(19) United States
(12) Patent Application Publication
(10) Pub. No.: US 2026/0295792 A1
(43) Pub. Date: Oct. 1, 2026

(54) DRIVING TOOL

(71) Applicant: MAKITA CORPORATION, Anjo-shi (JP)

(72) Inventors: Noriyuki NISHIDO, Anjo-shi (JP); Toshiro HIRAYAMA, Anjo-shi (JP)

(73) Assignee: MAKITA CORPORATION, Anjo-shi (JP)

(21) Appl. No.: 19/634,898

(22) Filed: Mar. 31, 2026

(30) Foreign Application Priority Data
Mar. 31, 2025 (JP) 2025-058403
Mar. 31, 2025 (JP) 2025-058545
Mar. 31, 2025 (JP) 2025-058546

(51) Int. Cl. B25C 1/06

(52) U.S. Cl. CPC B25C 1/06

(57) ABSTRACT

A driving tool includes a speed reduction mechanism that reduces an output of an electric motor and a hammer that is driven to rotate by an output transmitted from the speed reduction mechanism to strike a driver to drive a nail. The driving tool further includes an inner housing that accommodates the electric motor, the speed reduction mechanism, and the hammer, and an outer housing that encloses the inner housing and is provided with a grip. The driving tool also includes an elastic coupling mechanism that elastically couples the inner housing and the outer housing to allow relative movement to absorb a reaction force generated when the hammer strikes the driver.

### CROSS-REFERENCE

This application claims priority to Japanese patent application serial number 2025-058403, 2025-058545, and 2025-058546, each filed on Mar. 31, 2025, the entire contents of which are incorporated herein by reference.

### TECHNICAL FIELD

This disclosure relates to a driving tool equipped with a striking mechanism in which a hammer, driven to rotate by the output of an electric motor, strikes a driver.

### BACKGROUND

A driving tool referred to as a loose-nail driver, which drives individual nails one by one is well known. The driving tool has a striking mechanism equipped with a hammer that is driven to rotate by the output of an electric motor. The hammer repeatedly moves axially between a striking position and a retracted position while rotating about its axis. The hammer and a rotating member that transmits rotational power to the hammer are each provided with a cam groove inclined with respect to the axial direction. A ball is positioned between the cam grooves formed in the two members. The hammer is guided by the engagement of the ball and the cam groove, and moves axially with respect to the rotating member while rotating about its axis.

Furthermore, the hammer is axially biased toward the striking position by a spring. When contacting the driver in the striking position, the hammer pushes the driver in the striking direction by both the rotating member's rotational force and the spring's biasing force. When the driver cannot be pushed any further in the striking direction, the hammer axially moves to the retracted position against the biasing force of the spring and rotates in an opposite direction in which the rotating member rotates by engagement between the ball and the cam groove. The spring stores energy by being pressed down. When the driver is completely disengaged, the hammer axially moves toward the striking position by the biasing force of the spring and rotates in the direction in which the rotating member rotates by the engagement between the ball and the cam groove. The driver is struck in the striking direction by the hammer that rotates about its axis. By repeating this series of operation, the hammer strikes the driver repeatedly.

The tip end of the driver repeatedly strikes the head of a driving member such as a nail. This causes the driving member to be driven into the workpiece. When the hammer strikes the driver, a reaction force is generated that pushes the striking mechanism, including the hammer, in the direction opposite to the striking direction.

The conventional driving tool disclosed in the prior art is tubular extending in an up-down direction. A driver is provided at the upper front end of the driving tool. The driver is struck in a forward direction. A striking mechanism is provided behind the driver. A speed reduction mechanism is provided below the striking mechanism. An electric motor is provided below the speed reduction mechanism. The striking mechanism and the speed reduction mechanism are housed in an inner housing. The entirety of the inner housing is covered by an outer housing. The electric motor is housed in a tubular grip that extends in the up-down direction. The grip is formed as part of the outer housing.

The conventional driving tool disclosed in the prior art has a grip at the upper end and a driver at the lower end. The driver is struck downward. The striking mechanism and the speed reduction mechanism are housed in a mechanism housing above the driver. The upper portion of the mechanism housing is covered by the outer housing. The lower portion of the mechanism housing is exposed outside. The electric motor is housed in the outer housing behind the striking mechanism and the speed reduction mechanism. The upper portion of the outer housing serves as the grip.

In conventional driving tools having a striking mechanism, vibrations generated in the housing that accommodates the hammer striking mechanism (inner housing) are sometimes transmitted directly to the outer housing, which is equipped with a grip. If the reaction force in the direction opposite to the striking direction, which is generated when the hammer strikes the driver, is transmitted to the grip, the working efficiency is reduced. In addition, the tool main body may tilt due to the reaction force, causing the striking direction of the driver to tilt.

The conventional striking tool disclosed in the prior art, which drives individual nails one by one, has a long tubular housing and a battery is attached to the rear of the housing. A nozzle extending downward is provided at the front of the housing. A user holds an approximately center of the housing and presses upward the switch actuator on the lower surface of the housing. The hammer rotates by the output of the electric motor in the housing, thereby striking the driver. The driver strikes the nail inserted in the nozzle. However, since the switch actuator is located on the lower surface of the housing, there is a concern that it may be difficult to see.

The conventional striking tool disclosed in the prior art is of a palm-grip type. In this striking tool, a grip that the user holds is formed on the upper surface of the housing. A nozzle extends downward from the lower surface of the housing on the opposite side of the grip. When the user presses the switch actuator on the left side surface of the housing, the hammer strikes the driver by the electric motor output. The driver strikes the nail inserted in the nozzle. When the user holds the grip with the right hand, the switch actuator is pressed with the thumb, allowing the user to easily apply force. On the other hand, when the grip is held with the left hand, the switch actuator must be pressed with the ring finger or another finger, which makes it more difficult to apply force than with the thumb. Therefore, the operation portion of the switch actuator may not be easy to operate.

As described above, the conventional striking tool disclosed in the prior art has a long tubular housing and a nozzle extending downward at the front of the housing. The user holds an approximately center of the housing and strikes a nail inserted in the nozzle with a driver that moves inside the nozzle. The front portion of the housing may move upward due to the counter reaction force generated when striking a nail.

In the conventional striking tool disclosed in the prior art a stick battery is inserted into the housing from the rear. The electric motor is located below the stick battery. The electric motor has a motor shaft extending in the front-rear direction. A hammer is positioned forward perpendicular to the electric motor shaft. The hammer rotates around a rotation axis perpendicular to the electric motor shaft to strike the driver. The driver moves downward along the nozzle to strike the nail. The center of gravity of the palm-grip type striking tool is positioned relatively close to the striking axis. Therefore, the amount of tilt of the housing generated by the reaction force generated when driving a nail is small.

### SUMMARY

Therefore, in a driving tool equipped with a striking mechanism in which a hammer repeatedly strikes a driver, it is required to suppress the transmission of vibrations generated in the inner housing that accommodates the hammer to the grip.

In addition, there is a need for a driving tool provided with a switch actuator that is easy to operate with either the left or right hand.

Furthermore, there is a need for a driving tool in which the center of gravity is brought closer to the striking axis such that the housing exhibits only a small amount of tilt due to the reaction force generated when striking a nail.

According to one feature of the present disclosure, a driving tool has a speed reduction mechanism, a hammer, an inner housing, and an outer housing. The speed reduction mechanism reduces the output of the electric motor. The hammer strikes the driver using the output of the speed reduction mechanism. The inner housing houses the electric motor, the speed reduction mechanism, and the hammer. The outer housing encloses the inner housing and has a grip. The driving tool has an elastic coupling mechanism . The elastic coupling mechanism elastically connects the inner housing and outer housing to allow relative movement.

Thus, the inner housing can move elastically relative to the outer housing. When the hammer strikes the driver, the reaction force in the direction opposite to the striking direction (reverse direction) is transmitted to the inner housing, causing the inner housing to move in the reverse direction. Since the inner housing moves elastically relative to the outer housing, vibration can be suppressed from being transmitted to the outer housing. As a result, vibration transmitted to the grip is also suppressed.

### BRIEF DESCRIPTION OF THE DRAWINGS

FIG. 1 is a perspective view of a driving tool according to a first embodiment of the present disclosure.

FIG. 2 is a right-side elevational view of the driving tool.

FIG. 3 is a right-side elevational view of the driving tool of FIG. 1, shown with a right portion of an outer housing removed to illustrate internal components.

FIG. 4 is an exploded perspective view of an inner housing of the tool main body.

FIG. 5 is an exploded perspective view of an electric motor, a speed reduction mechanism, and a striking mechanism.

FIG. 6 is a cross-sectional view of the rotating member taken along line VI-VI in FIG. 2 with the rotating member in a striking position.

FIG. 7 is a side elevational view of the striking mechanism with the rotating member in the striking position.

FIG. 8 is a cross-sectional view of the rotating member taken along line VI-VI of FIG. 2, illustrating the rotating member in a retracted position.

FIG. 9 is a side elevational view of the striking mechanism, illustrating the rotating member in the retracted position.

FIG. 10 is a cross-sectional view of the tool main body taken along line X-X of FIG. 6, in a state prior to striking a fastener.

FIG. 11 is a cross-sectional view of the rotation member taken along line XI-XI in FIG. 6 with the rotating member in the striking position.

FIG. 12 is a cross-sectional view of the rotating member corresponding to FIG. 11 with the rotating member in the retracted position.

FIG. 13 is a cross-sectional view of the tool main body corresponding to FIG. 10 in a state immediately prior to striking the fastener.

FIG. 14 is a cross-sectional view of the tool main body corresponding to FIG. 10 in a state immediately after striking the fastener.

FIG. 15 is a cross-sectional view of the switch actuator taken along line XV-XV in FIG. 3, with the switch actuator in an initial position.

FIG. 16 is a cross-sectional view of the switch actuator corresponding to FIG. 15, illustrating the switch actuator pressed.

FIG. 17 is a right-side elevational view of the driving tool according to a second embodiment of the present disclosure.

FIG. 18 is a right-side elevational view of the driving tool with a right portion of the outer housing removed.

FIG. 19 is a cross-sectional view of the tool main body taken along line XIX-XIX of FIG. 17.

FIG. 20 is an exploded perspective view of the inner housing of the tool main body.

FIG. 21 is a right-side elevational view of the driving tool according to a third embodiment of the present disclosure.

FIG. 22 is a perspective view of the driving tool according to a fourth embodiment of the present disclosure.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term "exemplary" used throughout this description means "serving as an example, instance, or illustration," and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form in order to avoid obscuring significant aspects of the exemplary embodiments presented herein.

According to other features of the present disclosure, the elastic coupling mechanism has a spring. The spring biases the inner housing in the striking direction. Therefore, when the inner housing receives a reaction force in the reverse direction, the spring absorbs the reaction force. Accordingly, when the hammer strikes the driver, transmission of vibration from the inner housing to the outer housing is suppressed. Moreover, the spring elastically urges the inner housing, which has moved in the reverse direction, back toward its initial position in the striking direction. Thus, transmission of the reaction force repeatedly generated as the hammer repeatedly strikes the driver from the inner housing to the outer housing is also suppressed

According to other features of the present disclosure, the spring is interposed between the upper outer surface of the inner housing and the upper inner surface of the outer housing facing the upper outer surface. Therefore, the spring is disposed at a location where the inner housing is likely to come into contact with the outer housing when the inner housing moves in the reverse direction. Accordingly, vibration transmitted from the inner housing to the outer housing can be efficiently suppressed.

According to other features of the present disclosure, the spring is located along the driver movement axis. Therefore, the reaction force in the reverse direction received by the hammer from the driver can be efficiently absorbed by the spring.

According to other features of the present disclosure, the inner housing has an outwardly projecting projection. The outer housing has a guide portion. The guide portion guides the projection portion in the striking direction. Therefore, the movement of the inner housing relative to the outer housing can be guided in the direction along the striking direction by the projection and the guide portion. Accordingly, the inner housing is prevented from moving in a direction inclined relative to the striking direction. This prevents the inner housing from undesirably coming into contact with the outer housing, thereby suppressing vibration transmitted to the outer housing.

According to other features of the present disclosure, the inner housing has an upper protrusion and a lower protrusion. The outer housing has an upper guide portion and a lower guide portion. The upper guide portion guides the upper protrusion. The lower guide portion guides the lower protrusion. The lower protrusion serves as a driver housing to accommodate a driver. Therefore, the inner housing is elastically coupled to the outer housing in the lower protrusion which also serves as the driver housing. Moreover, the inner housing is elastically coupled to the outer housing at the upper protrusion on the opposite side of the lower protrusion. With the elastic coupling mechanism provided on both the striking direction side and the reverse direction side, the inner housing can be stably supported.

According to other features of the present disclosure, the elastic member of the elastic coupling mechanism is provided between the outer circumferential surface of the protrusion and the inner circumferential surface of the guide portion. Therefore, by interposing the elastic member, direct contact between the outer circumferential surface of the protrusion and the inner circumferential surface of the guide portion is prevented. As a result, vibration transmitted from the inner housing to the outer housing can be effectively suppressed.

According to other features of the present disclosure, the spring of the elastic coupling mechanism biases the inner housing in the striking direction. The protrusion serves as a spring seat to support the spring. Therefore, while maintaining a simple structure for the elastic coupling mechanism, the spring can be supported in alignment with the striking direction.

According to other features of the present disclosure, the inner housing is formed by integrally connecting the motor housing, gear housing, and hammer housing. The motor housing houses the electric motor. The gear housing houses the speed reduction mechanism. The hammer housing houses the striking mechanism including the hammer. Thus, each structure in the power transmission path from the electric motor to the hammer is housed in an integrally formed inner housing. The inner housing and the accommodated structures vibrate integrally due to the reaction force when the hammer strikes the driver. Therefore, the power transmission from the electric motor to the hammer is prevented from being interrupted by the vibration. In addition, by elastically supporting the entire inner housing and the accommodated structures with respect to the outer housing, vibration transmitted from the inner housing to the outer housing can be efficiently suppressed.

According to other features of the present disclosure, the grip of the outer housing is located on a side opposite to the striking direction of the driver and is positioned on the driver movement axis. Accordingly, the grip, which is held by the user, is positioned on the line of action of the reaction force generated when the hammer strikes the driver. Therefore, the inner housing can move smoothly relative to the outer housing in both the striking and the reverse directions while the user holds the grip. This prevents the inner housing and the driver from tilting relative to the striking direction due to the reaction force.

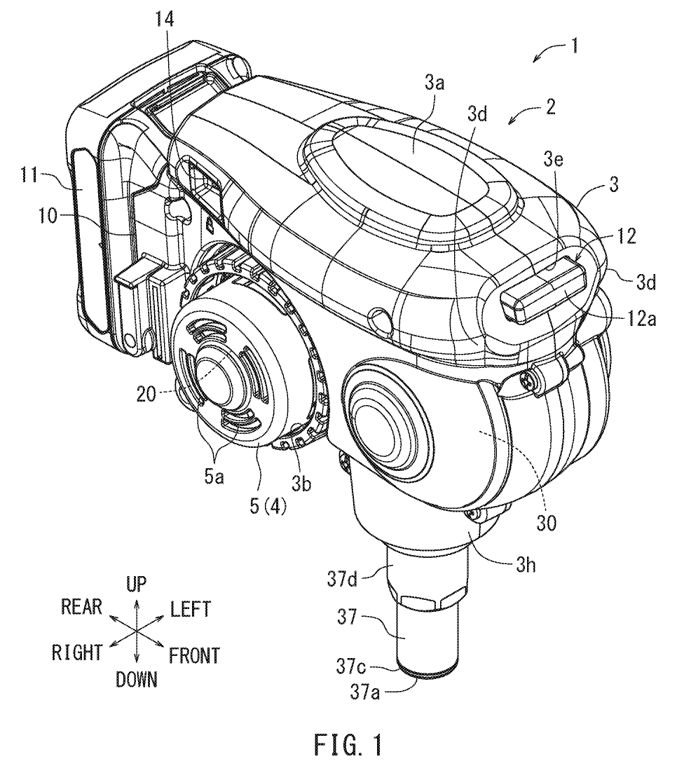

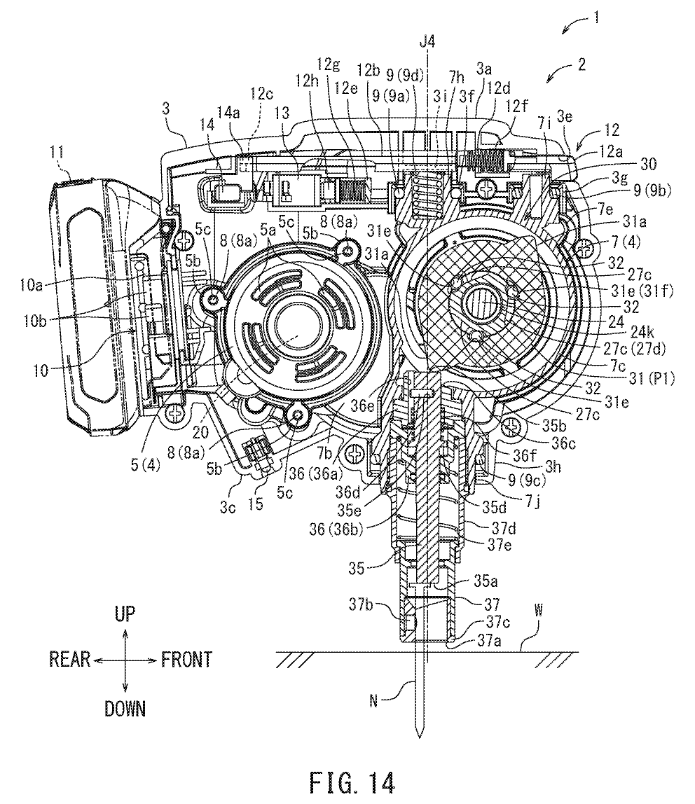

Next, a first embodiment of the present invention will be described with reference to FIGS. 1 to 16. In this disclosure, a driving tool 1, which may be referred to as a loose-nail driver or a nailer, is illustrated as an example of a driving or striking tool. In the driving tool 1, a driver is configured to repeatedly strikes the head of a driving member, such as a nail, to strike the driving member into the workpiece. In the following description, a striking direction of the driver is defined as downward and a direction opposite to the striking direction is defined upward. The terms front-rear (longitudinal) and left-right (lateral) directions are based on the direction viewed from the user situated behind the driving tool 1.

As shown in FIG. 1, a tool main body 2 of the driving tool 1 is covered by an outer housing 3 (main body housing), which has a front surface and extends in a front-rear (longitudinal) direction. The outer housing 3 is a half-split structure that can be divided into right and left halves. An upper surface of the outer housing 3 is provided with a grip 3a . The driving tool 1 of the present disclosure is commonly referred to as a palm-grip type. A user holds the grip 3a with a hand placed over it. A tubular guide portion 3h is provided on the front bottom surface of the outer housing 3. A tubular nail guide 37 protrudes downward from the guide portion 3h. An opening 37a is provided at the lower end of the nail guide 37. The opening 37a is located at a left-right center of a lower portion of the outer housing 3.

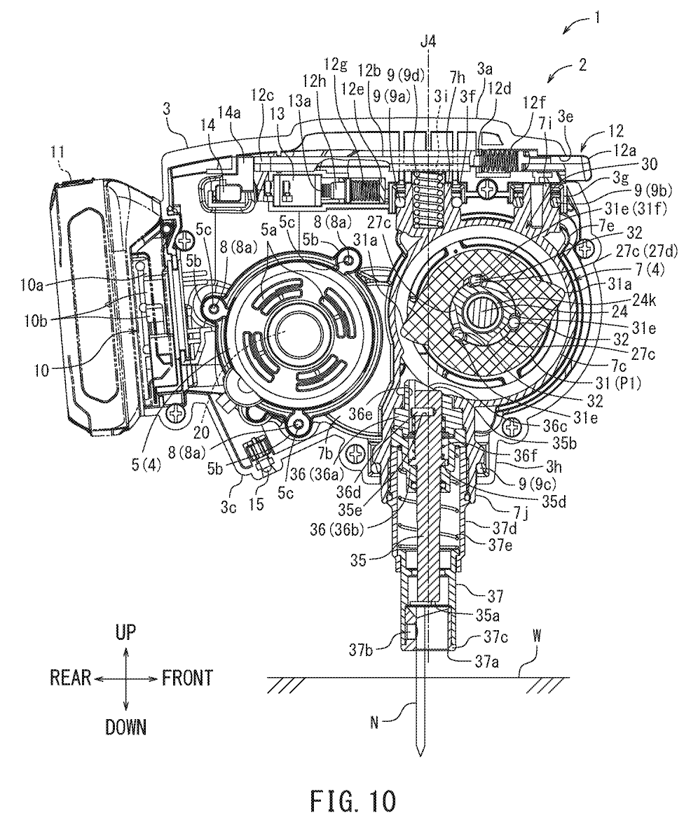

As shown in FIG. 10, a driving member (struck member) N is mounted on an inner peripheral side of the nail guide 37. The driving member N is mounted with the head positioned upward and the leg protruding from the opening 37a. The leg of the driving member N is brought into contact with a workpiece W. The driver 35 in the tool main body 2 repeatedly strikes the head of the driving member N, thereby driving the member N into the workpiece W.

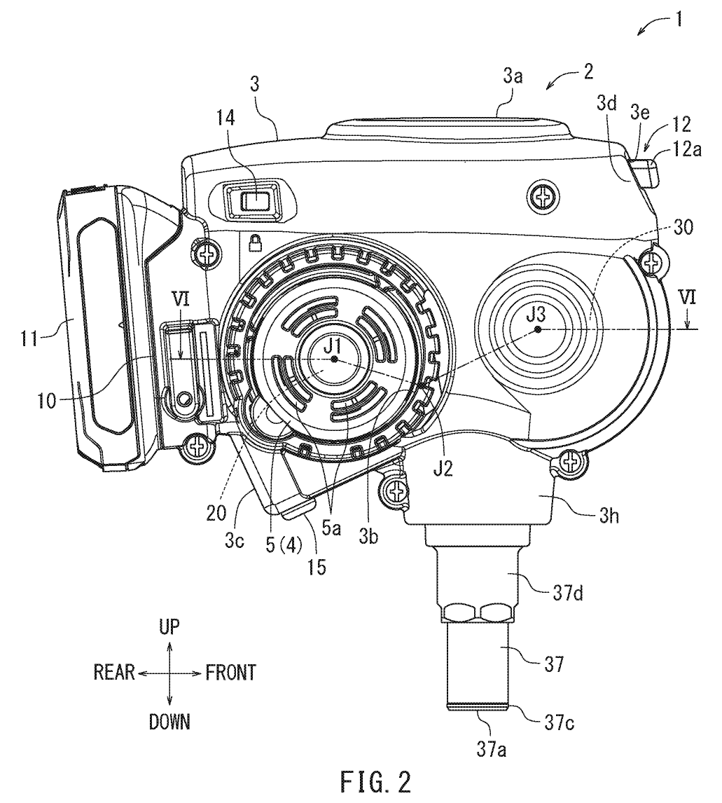

As shown in FIG. 2, a circular-shaped exposed opening 3b is provided on the right side of the outer housing 3. A right portion of an motor housing 5 (described below) is exposed to the outside of the outer housing 3 through the exposed opening 3b. The exposed opening 3b has a diameter larger than that of the motor housing 5 to avoid direct contact with the motor housing 5. The lower portion of the outer housing 3 is provided with a protrusion 3c that extends downward. The protrusion 3c is provided behind the guide portion 3h and at lower front side of a battery attachment portion 10 described below. A work light 15 is provided in the protrusion 3c. The work light 15 includes a light-emitting member, such as an LED, that emits light when supplied with electric power. The work light 15 emits light toward the lower region of the opening 37a.

As shown in FIG. 2, a battery attachment portion 10 is provided on the rear surface of the outer housing 3. A rechargeable battery 11 can be removably attached to the battery attachment portion 10. The battery 11 is, for example, a lithium-ion battery with an output voltage of 10.8 V. The battery 11 can be removed from the battery attachment portion 10 and repeatedly recharged using a separately dedicated charger. The battery 11 can be used as a power source for other rechargeable power tools such as screw tightening tools and electric drills.

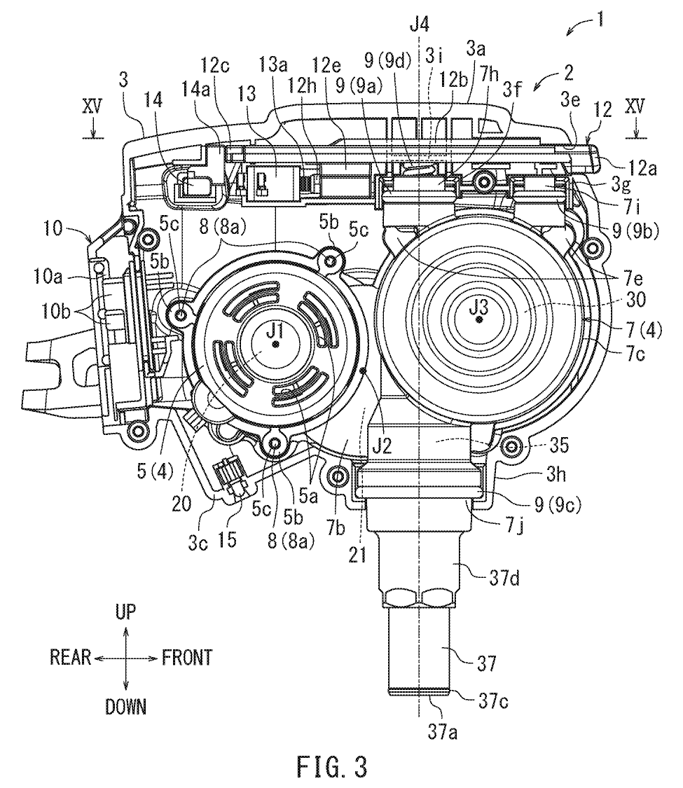

As shown in FIG. 3, the battery attachment portion 10 is provided with a rail 10a and a connection terminal 10b. The rail 10a extends in the up-down direction at the right and left ends of the battery attachment portion 10, respectively. The connection terminal 10b extends in the up-down direction between the left and right rails 10a, parallel to the rails 10a, and protrudes rearward from the battery attachment portion 10. The battery 11 can be attached to the battery attachment portion 10 by sliding it downward along the rail 10a. The battery 11 can be removed from the battery attachment portion 10 by sliding it upward along the rail 10a.

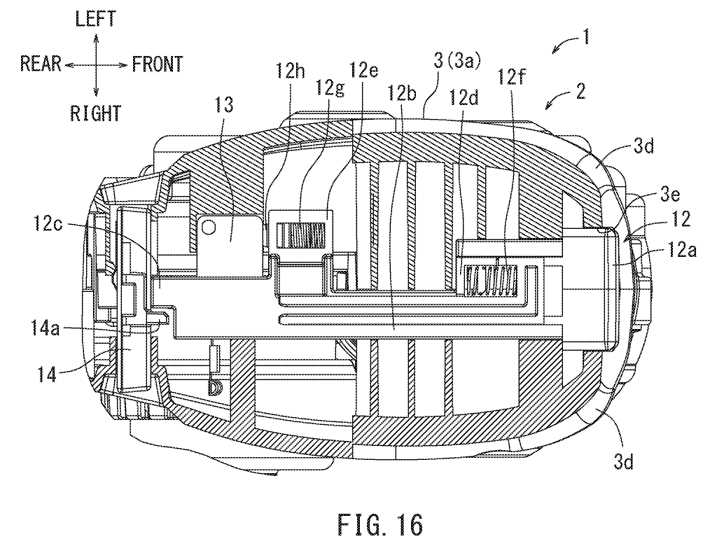

As shown in FIG. 1, the upper front surface of the outer housing 3 is provided with a curved surface portion 3d having curvature in the up-down and left-right directions. A through hole 3e is provided and is surrounded by the curved portion 3d. The through hole 3e is formed in a rectangular shape and passes through the outer housing 3 in the front-rear direction. A switch operation lever 12 extends through the through hole 3e. The switch operation lever 12 is slidable in the front-rear direction and is biased toward the front. A front surface of the switch operation lever 12 is the switch operation portion 12a. The switch operation portion 12a is positioned at a left-right center of the front surface of the outer housing 3. The switch operation portion 12a operates an electrical switch 13 of the electric motor 20 described below. The user can operate the switch operation portion 12a by hooking a finger of the hand gripping the grip 3a onto the switch operation portion 12a and pulling it rearward. As shown in FIG. 2, the switch operation portion 12a is positioned forward of the curved portion 3d when not pulled rearward. As shown in FIG. 16, the switch operation portion 12a is positioned slightly forward of the curved portion 3d when pulled rearward.

As shown in FIG. 2, a lock lever 14 is provided at the upper rear portion of the tool main body 2. The lock lever 14 is positioned at the lower rear of the grip 3a and in front of the battery attachment portion 10. The lock lever 14 moves in the left-right direction and interferes with an arm 12b of the switch operation portion 12a, which is described below. The lock lever 14 is slidable relative to the outer housing 3 when pushed in the left-right direction. Sliding the lock lever 14 in the left-right direction switches between a lock release state, where the pull operation of the switch operation portion 12a is enabled, and a lock state, where the pull operation is restricted.

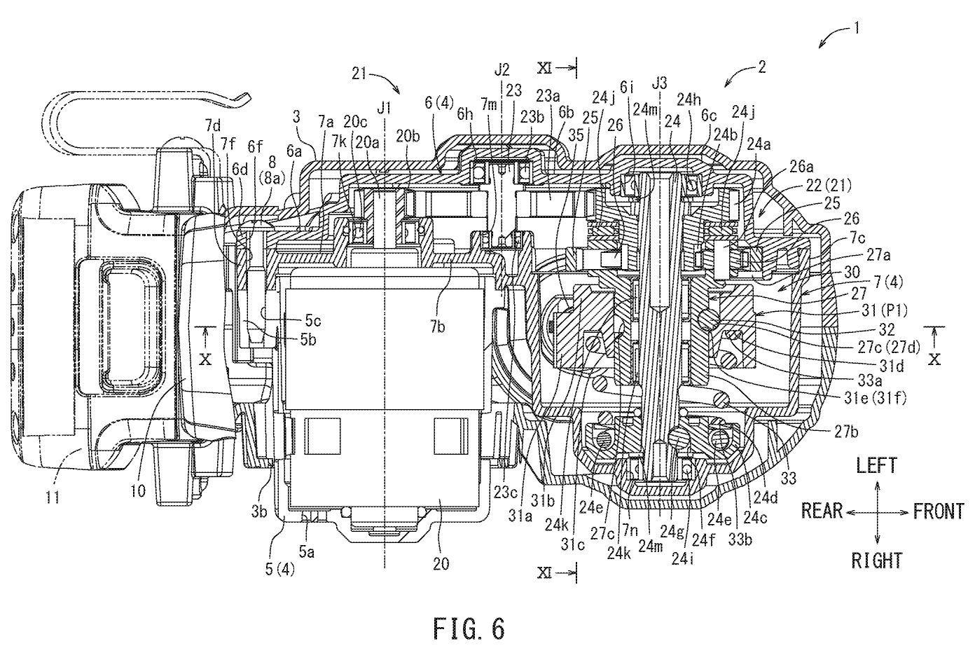

As shown in FIG. 3, the driving tool 1 has an inner housing 4 inside the outer housing 3. The inner housing 4 houses an electric motor 20, a speed reduction mechanism 21, a striking mechanism 30, and other mechanism units in an assembled form. A motor rotation axis J1 of the electric motor 20, an intermediate shaft rotation axis J2 (an idler gear rotation axis) of the idler gear 23a (see FIG. 6) of the speed reduction mechanism 21, and the hammer rotation axis J3 of the striking mechanism 30 extend in the left-right direction and are substantially parallel to each other. A driver movement axis (striking axis) J4, along which the driver 35 (see FIG. 10) moves, extends in the up-down direction, and is substantially perpendicular to the motor rotation axis J1, the idler gear rotation axis J2, and the hammer rotation axis J3. The grip 3a is positioned on an upper extension of the driver movement axis J4.

As shown in FIG. 3, the intermediate shaft rotation axis J2 is located between the driver movement axis J4 and the motor rotation axis J1 in the front-rear direction. The intermediate shaft rotation axis J2 is located below the motor rotation axis J1. The hammer rotation axis J3 is located forward of the driver movement axis J4. The hammer rotation axis J3 is located above the motor rotation axis J1. The motor rotation axis J1 and the intermediate shaft rotation axis J2 are arranged so as to overlap with the striking mechanism 30 and the battery attachment portion 10 in the up-down direction. The hammer rotation axis J3 is arranged so as to overlap with the battery attachment portion 10 in the up-down direction.

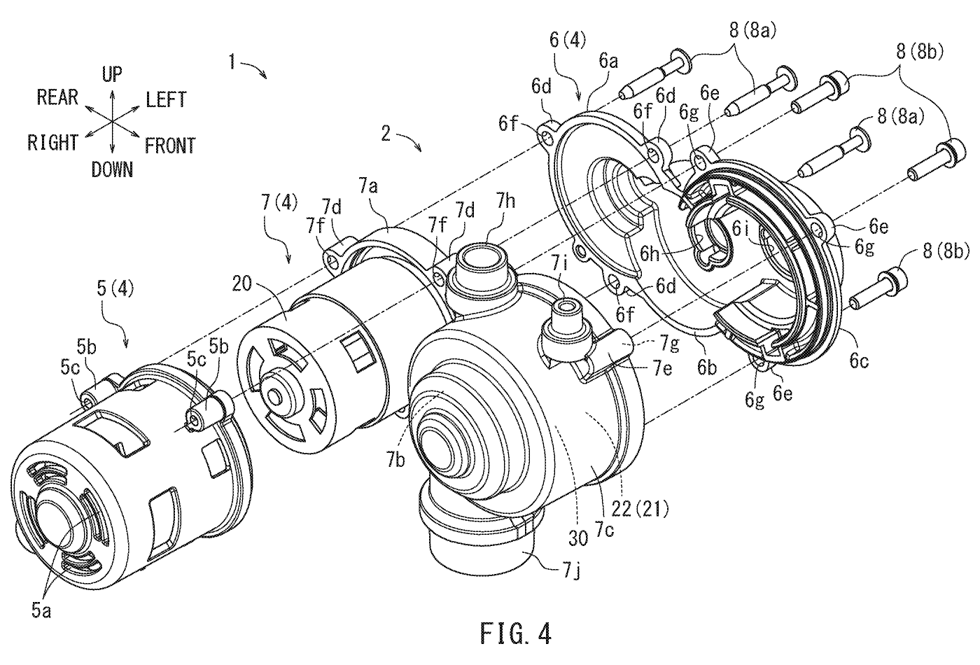

As shown in FIG. 4, the inner housing 4 is formed by integrally assembling the motor housing 5, gear housing 6, and hammer housing 7 with a plurality of fastening members 8. The motor housing 5 is tubular, with a bottom on the right side and an opening on the left side. The bottom of the motor housing 5 has a vent hole 5a that penetrates the motor housing 5. A plurality of bosses 5b are provided on the outer peripheral surface of the left side of the motor housing 5 to protrude radially outward. The bosses 5b are tubular and extend in the left-right direction. The inner circumferential surfaces of the bosses 5b are provided with female threads 5c extending in the left and right directions. The electric motor 20 is housed in the motor housing 5.

As shown in FIG. 4, the gear housing 6 has a motor cap 6a, an idler gear compartment 6b, and a spindle compartment 6c. The motor cap 6a, the idler gear compartment 6b, and the spindle compartment 6c are integrally connected. The motor cap 6a is a disk-shaped member covering the motor housing 5 and the clamping portion 7a described below from the left side. The idler gear compartment 6b is connected to a front portion of the motor cap 6a. The idler gear compartment 6b is tubular, with a bottom on the left side and an opening on the right side. The idler gear compartment 6b houses an intermediate shaft 23 described below and the idler gear 23a (see FIG. 6). The spindle compartment 6c is connected to the front portion of the idler gear compartment 6b. The spindle compartment 6c is tubular, with a bottom on the left side and an opening on the right side. The spindle compartment 6c houses a spindle 24 and a left portion of the planetary reduction mechanism 22, which will be described later (see FIG. 6).

As shown in FIG. 4, the outer circumferential surface of the electric motor cap 6a has a plurality of bosses 6d protruding radially outward. The bosses 6d are tubular and extend in the left-right direction. Each boss 6d has a through holes 6f extending in the left-right direction. The outer circumferential surface of spindle compartment 6c has a plurality of bosses 6e protruding radially outward. The bosses 6e are tubular and extend in the left-right direction. Each bosses 6e has a through holes 6g extending in the left-right direction.

As shown in FIG. 4, the hammer housing 7 has a clamping portion 7a, an idler gear compartment 7b, and a striking mechanism compartment 7c. The clamping portion 7a, the idler gear compartment 7b, and the striking mechanism unit 7c are integrally connected. The clamping portion 7a is a disk-shaped member covering the motor housing 5 from the left side. An idler gear compartment 7b is connected to the front portion of clamping portion 7a. The idler gear compartment 7b is a disk-shaped member covering the idler gear compartment 6b of gear housing 6 from the right side (see FIG. 3). As shown in FIG. 6, the idler gear compartment 7b cooperates with the idler gear compartment 6b to accommodate the intermediate shaft 23 and the idler gear 23a described below. In other words, the idler gear compartment 7b also functions as a gear housing.

As shown in FIG. 4, the striking mechanism compartment 7c is connected to the front portion of the idler gear compartment 7b. The striking mechanism compartment 7c is tubular, with a bottom on the right side and an opening on the left side. As shown in FIG. 6, the striking mechanism compartment 7c cooperate with the spindle compartment 6c to accommodate a right portion of the planetary reduction mechanism 22 and the striking mechanism 30, which are described below. In other words, the spindle compartment 6c also functions as a hammer housing.

As shown in FIG. 4, the outer circumferential surface of the clamping portion 7a has a plurality of bosses 7d protruding radially outward. The bosses 7d are tubular and extend in the left-right direction. Each boss 7d has a through holes 7f extending in the left-right direction. The outer circumferential surface of the striking mechanism compartment 7c has a plurality of bosses 7e protruding radially outward. Each boss 7e is tubular and extends in the left-right direction. The inner circumferential surfaces of each boss 7e is formed with a female threads 7g extending rightward toward the right side.

As shown in FIG. 4, a plurality of male screws 8a as fastening members 8 are inserted through the through holes 6f of the gear housing 6 and the through holes 7f of the hammer housing 7 from left to right. The plurality of male screws 8a are fastened into the respective female thread 5c of the motor housing 5. A plurality of hexagon socket head bolts 8b, serving as fastening members 8, are inserted through the through holes 6g of the gear housing 6 from left to right. The plurality of hexagon socket head bolts 8b are fastened into the respective female thread 7g of the hammer housing 7. As shown in FIG. 6, the bolts having the male threads 8a fasten the three components together by clamping the clamping portion 7a between the motor housing 5 and the motor cap 6a in the left-right direction. The clamping portion 7a and the motor cap 6a cover the left opening of the motor housing 5. In other words, the clamping portion 7a and the motor cap 6a also function as a motor housing for housing the electric motor 20.

As shown in FIG. 4, the upper outer surface of the hammer housing 7 has an upper protrusions 7h and an upper protrusion 7i protruding upward. The lower outer surface of the hammer housing 7 has a lower protrusion 7j protruding downward. The upper protrusion 7h, 7i and the lower protrusion 7j are tubular, each having an axis extending in the up-down (vertical) direction. As shown in FIG. 3, the upper protrusion 7h and the lower protrusion 7j are arranged along the driver movement axis J4 and aligned in the up-down direction. The lower protrusion 7j surrounds the driver guide 36 (see FIG. 10) and serves as a driver housing for accommodating the driver 35. The upper protrusion 7i is positioned in front of the upper protrusion 7h and protrudes to substantially the same vertical height as the upper protrusion 7h (see FIG. 3).

As shown in FIG. 3, guide portions 3f and 3g are provided on the upper inner surface of outer housing 3. The guide portions 3f and 3g are bottomed tubular portions that respectively cover the upper protrusions 7h and 7i from above and laterally. A guide portion 3h is provided on the lower inner surface of the outer housing 3. The guide portion 3h is a tubular member that laterally covers the lower protrusion 7j and serves as a support for the driver guide 36. An elastic member 9a is provided as an elastic coupling mechanism 9 between the outer circumferential surface of the upper protrusion 7h and the inner circumferential surface of the guide portion 3f. The elastic member 9a is a rubber O-ring or may be a rubber O-ring having an inner diameter that is substantially equal to the outer diameter of the upper protrusion 7h. Direct contact between the upper protrusion 7h and the guide portion 3f is prevented by interposing the elastic member 9a.

As shown in FIG. 3, an elastic member 9b is provided as an elastic coupling mechanism 9 to avoid direct contact between the outer circumferential surface of the upper protrusion 7i and the inner circumferential surface of the guide portion 3g. The elastic member 9b is a rubber O-ring or may be a rubber O-ring having an inner diameter that is substantially equal to the outer diameter of the upper protrusion 7i. Furthermore, an elastic member 9c is provided as the elastic coupling mechanism 9 to avoid mutual contact between the outer circumferential surface of the lower protrusion 7j and the inner circumferential surface of the guide portion 3h. The elastic member 9c is a rubber O-ring or may be a rubber O-ring having an inner diameter that is substantially equal to the outer diameter of the lower protrusion 7j. Thus, the hammer housing 7 is elastically held to prevent direct contact with the outer housing 3. Furthermore, the motor housing 5 and the gear housing 6 are connected to the hammer housing 7 while avoiding direct contact with the outer housing 3. Accordingly, the inner housing 4 as a whole is elastically held such that direct contact with the outer housing 3 is avoided.

The elastic members 9a and 9b also act as cushions to prevent collision between the upper outer surface of the hammer housing 7 and the upper inner surface of the outer housing 3 when the hammer housing 7 moves upward along the driver movement axis J4 by pushing and contracting the spring 9d (described below) due to a reaction force caused by a hammering operation. The elastic member 9c also acts as a cushion to prevent collision between the lower outer surface of the hammer housing 7 and the lower inner surface of the outer housing 3 when the compressed spring 9d returns to its initial state by its elastic force and biases the hammer housing 7 downward.

As shown in FIG. 10, a spring 9d, which is a coil spring and functions as part of the elastic coupling mechanism 9, is inserted into an inner recess of the upper protrusion 7h. The guide portion 3f on the inner upper surface of the outer housing 3 has a closed upper end. The closed upper end of the guide portion 3f serves as a spring seat 3i to receive the upper end of the spring 9d. The spring 9d is interposed between the spring seat 3i and the upper protrusion 7h along the driver movement axis J4. The spring 9d biases the inner housing 4 downward toward the outer housing 3. As shown in FIG. 1, immediately after the tip end 35a of the driver 35 strikes the head of the driving member N, the inner housing 4 moves upward due to the reaction force caused by a hammering operation. However, since the inner housing 4 is biased downward by the spring 9d, it remains at a height that avoids contact with the inner upper surface of the outer housing 3 even when it moves upward. Accordingly, direct contact between the inner housing 4 and the outer housing 3 is prevented.

The electric motor 20 shown in FIG. 6 is a DC brush motor. The motor shaft 20a of the electric motor 20 protrudes leftward (in a first lateral direction) along the motor rotation axis J1. The electric motor shaft 20a is rotatably supported by a bearing 20c. The bearing 20c is inserted through and supported by a circular hole 7k provided in the clamping portion 7a of the hammer housing 7. A drive-side spur gear 20b is attached to the left end of the electric motor shaft 20a. The drive-side spur gear 20b is housed between the motor cap 6a and the clamping portion 7a.

As shown in FIG. 6, an intermediate shaft 23 is housed in the gear housing 6 and hammer housing 7 and extends in the left-right directions along the intermediate shaft rotation axis J2. The intermediate shaft 23 is rotatably supported by bearings 23b and 23c. The bearing 23b is inserted into and supported in a circular recess 6h provided on the inner surface of idler gear compartment 6b of the gear housing 6. The bearing 23c is inserted into and supported in a circular recess 7m provided on the inner surface of the idler gear compartment 7b of the hammer housing 7. An idler gear 23a is attached to a central portion of the intermediate shaft 23 in the left-right (lateral) direction.

As shown in FIG. 6, a spindle 24 is housed in the gear housing 6 and the hammer housing 7 and extends in the left-right direction along the hammer rotation axis J3. The spindle 24 is rotatably supported by bearings 24h and 24i. The bearing 24h is inserted into and supported by the circular recess 6i provided in the inner surface of the spindle compartment 6c of gear housing 6. The bearing 24i is inserted into and supported by the circular recess 7n provided in the inner surface of the striking mechanism compartment 7c of the hammer housing 7. A driven-side spur gear 24a is attached to the left end of the spindle 24. The drive-side spur gear 20b, the idler gear 23a, and the driven-side spur gear 24a together form a single-stage speed reduction mechanism 21. The drive-side spur gear 20b and the driven-side spur gear 24a respectively engage the idler gear 23a. The output of the electric motor 20 is transmitted from the drive-side spur gear 20b to the driven-side spur gear 24a via the idler gear 23a with speed reduction.

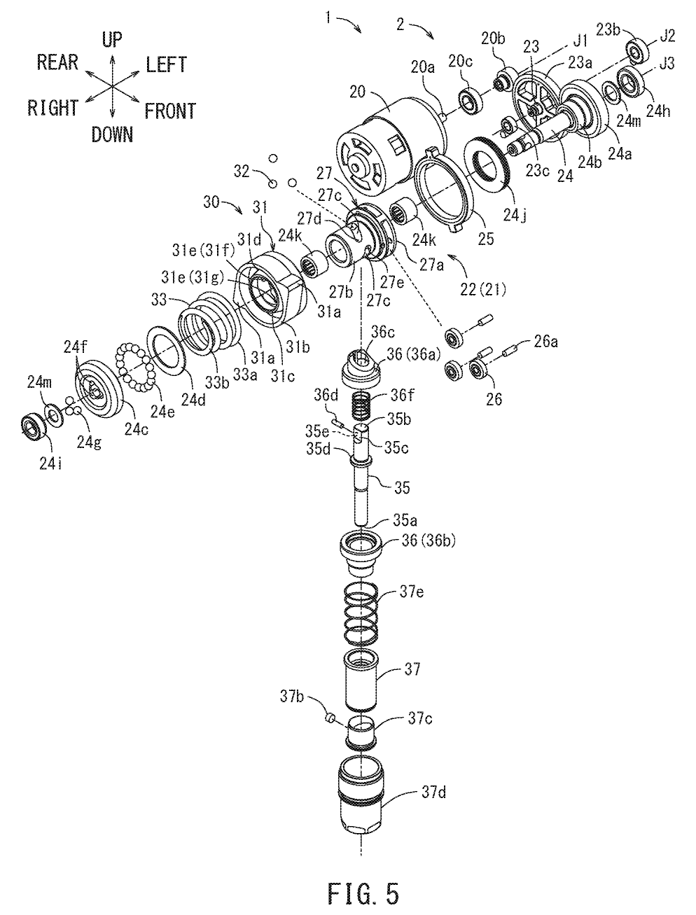

As shown in FIG. 6, a rotation member 31 having a carrier 27 and a hammer 31a is provided on the outer circumference of the center of the spindle 24 in the left-right (lateral) direction. A planetary reduction mechanism 22 is provided as a speed reduction mechanism 21 in the power transmission path from the spindle 24 to the rotation member 31. The planetary reduction mechanism 22 has a single-stage planetary gear train. The sun gear 24b of the planetary reduction mechanism 22 is provided on the outer circumferential surface of the spindle 24. The circular internal gear 25 is provided radially outward of the sun gear 24b. The internal gear 25 is non-rotatably supported by the hammer housing 7 by a rib (see FIG. 5) that protrudes radially outward. Three planetary gears 26 are provided between the sun gear 24b and the internal gear 25 in the radial direction. Each planetary gear 26 rotates about a support shaft 26 extending in the left-right (lateral) direction while revolving around the sun gear 24b.

As shown in FIG. 6, each of the three planetary gears 26 is supported by the disk portion 27a of the carrier 27 via the support shaft 26a. The carrier 27 has a tubular portion 27b extending rightward (in a second lateral direction) from the disk portion 27a. The tubular portion 27b has a smaller diameter than the disk portion 27a. A thrust bearing 24j is provided between the left side of the disk portion 27a of the carrier 27 and the driven-side spur gear 24a of the spindle 24 in the left-right (lateral) direction. The carrier 27 receives the axial force acting on the spindle 24 via the rotation member 31, but rotates smoothly about its axis by being disposed adjacent to the thrust bearing 24j.

As shown in FIG. 6, a radial bearing 24k is provided between the outer circumferential surface of the spindle 24 and the inner diameter of the tubular portion 27b. The carrier 27 rotates at a slower speed than the spindle 24 by means of the planetary reduction mechanism 22. By providing the radial bearing 24k, the spindle 24 and the carrier 27 are allowed to rotate about the hammer rotation axis J3 at different rotational speeds.

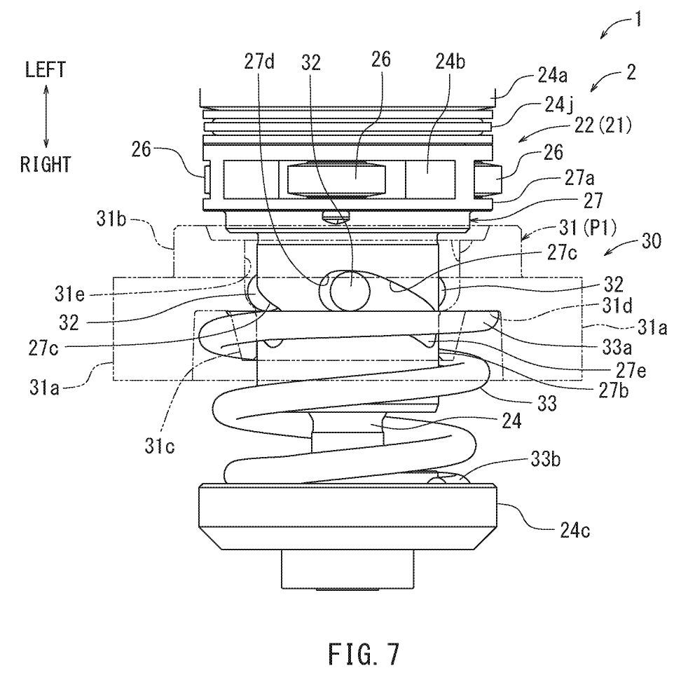

As shown in FIG. 7, three cam grooves 27c are provided on the outer circumferential surface of the tubular portion 27b of the carrier 27. The cam grooves 27c extend obliquely in the axial direction with respect to the circumferential direction of the tubular portion 27b. The cam grooves 27c have an impact position end 27d at the left (a first lateral) end and a retracted position end 27e at the right (a second lateral) end. A metal ball 32 is interposed between each cam groove 27c and a corresponding cam groove 31e of the rotation member 31.

As shown in FIG. 5, the rotation member 31 is formed in a cylindrical shape, extending in the left-right (lateral) direction. The rotation member 31 is formed with a double structure including an outer tubular portion 31b disposed radially outside and an inner tubular portion 31c disposed radially inside. Two hammers 31a protrude radially outward from the outer tubular portion 31b. The two hammers 31a are arranged substantially symmetrically at 180 degrees in the circumferential direction. A hollow portion between the outer tubular portion 31b and the inner tubular portion 31c has a bottom surface 31d at the left (the first lateral) end. Three cam grooves 31e are provided on the inner circumferential surface of the inner tubular portion 31c. Each cam groove 31e includes an inclined surface that extends obliquely in the axial direction relative to the circumferential direction of the inner tubular portion 31c. The front end of each cam groove 31e in the rotating direction (counterclockwise in FIG. 1) defines an impact position end 31f, and the rear end defines a retracted position end 31g.

As shown in FIG. 6, a disk-shaped assist member 24c is attached to the right end of spindle 24. The assist member 24c is provided between the bearing 24i and the rotation member 31 in the left-right direction. As shown in FIG. 5, three grooves 24f extending radially outward are provided on the inner circumferential surface of the rotation member 31. A ball is interposed between each groove portion 24f and the spindle 24 as an anti-rotation member 24g. A washer 24m is provided between the right side of the assist member 24c and the bearing 24i to prevent contact between them. As a result, the assist member 24c rotates smoothly about the axis together with the spindle 24 at the same rotational speed.

As shown in FIG. 6, a plurality of balls 24e (see FIG. 5) are inserted into a recess on the left side of the assist member 24c. A washer 24d is provided on the left side of the assist member 24c to prevent the balls 24e from coming out. A spring 33, a coil spring, is provided between the bottom surface 31d of the rotation member 31 and the washer 24d. The spring 33 contacts the bottom surface 31d at the first end 33a on the left side, and the washer 24d at the second end 33b on the left side. The spring 33 is conical, with the first end 33a having a larger diameter than the second end 33b. The washer 24d is pressed against the assist member 24c by the biasing force of the spring 33. Therefore, the washer 24d rotates about its axis together with the assist member 24c. The rotating member 24c and the washer 24d are allowed to rotate relative to each other to some extent via the interposition of the balls 24e.

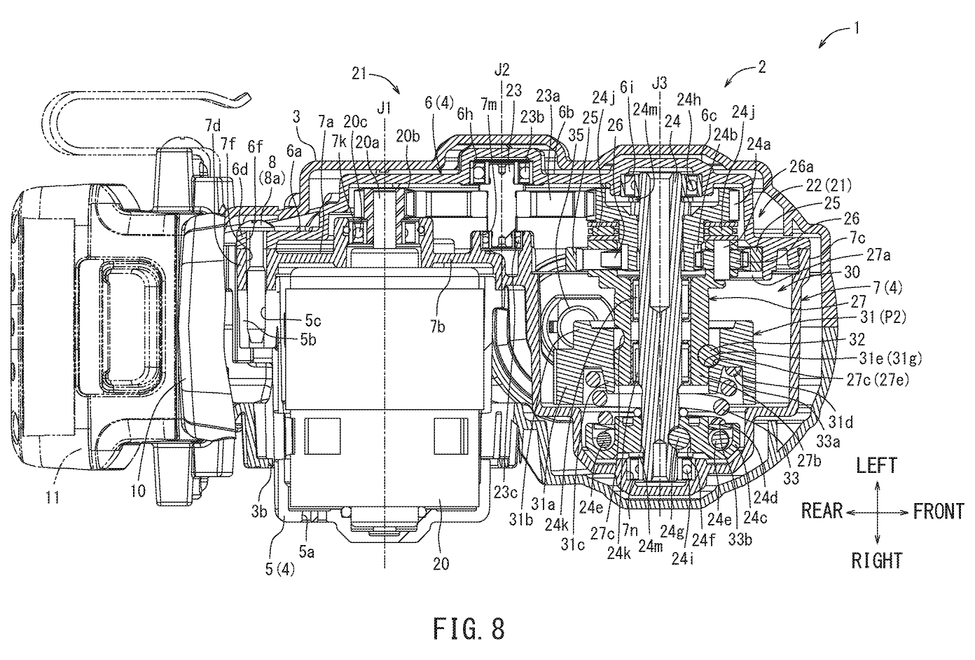

As shown in FIGS. 6 and 8, the rotation member 31 is biased leftward along the hammer rotation axis J3 by the spring 33. The rotation member 31 is movable in the left-right directions with respect to the carrier 27 between a striking position P1 on the left side and a retracted position P2 on the right side. The hammer 31a strikes the driver 35 in the striking position P1. The hammer 31a does not strike the driver 35 in the retreat position P2. When rotation member 31 is in striking position P1, the ball 32 is disposed between a striking end position 27d of the cam groove 27c and a striking end position 31f of the cam groove 31e. When the rotation member 31 is in the retracted position P2, the ball 32 is between a retracted end position 27e of the cam groove 27c and a retracted end position 31g of the cam groove 31e.

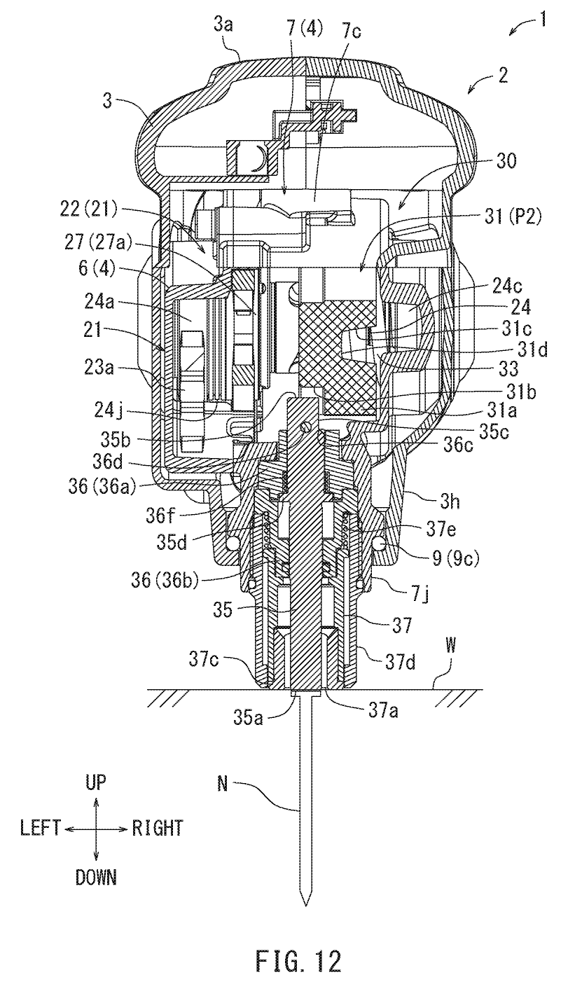

As shown in FIG. 5, the driver 35 extends in the up-down (vertical) direction. The driver 35 has a tip end 35a at the lower end and an impact-receiving portion 35b at the upper end. The tip end 35a contacts the head of the driving member N (see FIG. 1). The impact-receiving portion 35b is configured to be struck by the hammer 31a. A notched portion 35c, which is formed in a flat shape, is provided on the right side of the impact-receiving portion 35b. The notched portion 35c extends in the up-down (vertical) and front-rear (longitudinal) directions. By providing the notched portion 35c, contact between the driver 35 and the hammer 31a in the retracted position P2 during axial rotation can be prevented (see FIG. 12). A flange 35d extending radially outward is provided in the center of the driver 35 in the up-down direction. In the upper portion of the driver 35, a hole 35e is provided which extends in a direction substantially perpendicular to the axial direction. A cylindrical anti-rotation pin 36d is inserted into the hole 35e.

As shown in FIG. 5, the driver guide 36 guides the vertical movement of the driver 35. The driver guide 36 includes an upper guide member 36a and a lower guide member 36b. The upper guide member 36a and the lower guide member 36b are cylindrical and connected to each other in the up-down direction. A hammer-side opening 36c is provided at the upper end of the upper guide member 36a. The hammer-side opening 36c is formed so as to be tilted downward from rear to front to avoid contact with the hammer 31a.

As shown in FIG. 10, a guide groove 36e extending in the up-down (vertical) direction is provided on the rear inner circumferential surface of the upper guide member 36a. The anti-rotation pin 36d protruding rearward from the driver 35 is inserted into the guide groove 36e. The anti-rotation pin 36d is slidable within the guide groove 36e in the up-down (vertical) direction. By the engagement of the anti-rotation pin 36d with the guide groove 36e, the driver 35 is prevented from rotating and is allowed to move in the up-down direction with respect to the driver guide 36. A spring 36f, a coil spring, is interposed between the upper surface of the inner circumference of the upper guide member 36a and the flange 35d of the driver 35 in the up-down direction. The driver 35 is biased downward with respect to the driver guide 36 by the spring 36f. This allows the tip end 35a of the driver 35 to be brought into close contact with the driving member N, thereby enabling the driving member N to be struck efficiently.

As shown in FIG. 10, a guide holder 37d is provided below the lower guide member 36b. The guide holder 37d guides the nail guide 37 in the up-down direction. The upper guide member 36a, the lower guide member 36b, and the guide holder 37d are attached to the inner circumference of the lower protrusion 7j of the hammer housing 7. A nail guide 37 is inserted into the inner circumferential side of the guide holder 37d. Downward displacement of the nail guide 37 is restricted by the inner circumferential bottom surface of the guide holder 37d. The guide holder 37d and the nail guide 37 serve as a driver guide for guiding the vertical movement of the driver 35. A spring 37e, a coil spring, is interposed between the lower surface of the lower guide member 36b and the upper surface of the nail guide 37 in the up-down direction. The nail guide 37 is biased downward with respect to the driver guide 36 by the spring 37e. This allows the opening 37a at the tip end of the nail guide 37 to be brought into close contact with the workpiece W while the driving member N is being driven into the workpiece W.

As shown in FIG. 10, a tubular magnet holder 37c is attached to the lower end of the nail guide 37. A magnet 37b is provided on the rear inner circumferential surface of the magnet holder 37c. The driving member N inserted in the nail guide 37 is held by the magnet 37b below the tip end 35a of the driver 35 so as to prevent if from falling.

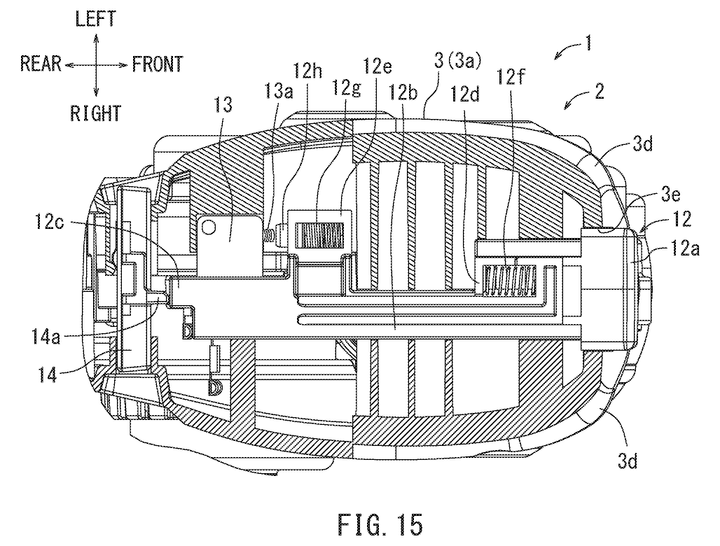

As shown in FIG. 15, the switch operation lever 12 has an arm 12b extending rearward from the switch operation portion 12a. The arm 12b extends, above the driver, from the front surface of the outer housing 3 toward the electrical switch 13 (see FIG. 10). The switch operation lever 12 has a box-shaped spring holder 12d integrally formed with the arm 12b behind the switch operation portion 12a. The spring holder 12d houses a return spring 12f, a coil spring. A rear end of the return spring 12f is supported by the inner circumferential surface of the outer housing 3. The return spring 12f biases the switch operation lever 12 forward with respect to the outer housing 3. Therefore, when not pulled by the user, the switch operation portion 12a is in an initial position protruding forward from the curved portion 3d of the outer housing 3.

As shown in FIG. 15, the switch operation lever 12 has a box-shaped spring holder 12e integrally formed with the arm 12b behind the spring holder 12d. The spring holder 12e includes a buffer spring 12g, a coil spring, and a stepped pin 12h. The stepped pin 12h protrudes rearward from the rear surface of the spring holder 12e and is prevented from coming out rearward from the spring holder 12e. The buffer spring 12g biases the stepped pin 12h rearward with respect to the actuator lever 12.

As shown in FIG. 15, an electrical switch 13 is provided behind the stepped pin 12h. The electrical switch 13 has a projection 13a protruding toward the front. The electrical switch 13 is in an off state when the projection 13a is not pushed rearward, and in an on state when pushed rearward. When the electrical switch 13 is in the on state, power is supplied from the battery 11 to the electric motor 20, thereby driving the electric motor 20 (see FIG. 10). The electrical switch 13 is located behind the driver 35 (see FIG. 10).

When the user pulls the switch operation portion 12a rearward as shown in FIG. 16, the stepped pin 12h moves rearward together with the arm 12b. While being biased rearward by the buffer spring 12g, the stepped pin 12h contacts the rearward projection 13a of the electrical switch 13. This enables the electrical switch 13 to be turned on. The movable length of the projection 13a in the front-rear direction is shorter than the amount of front-rear movement of the switch operation portion 12a when it is pulled. By interposing the buffer spring 12g and the stepped pin 12h between the switch operation lever 12 and the electrical switch 13, it becomes possible to reliably switch the electrical switch 13 on and off, while ensuring a sufficient operation stroke of the switch operation portion 12a.

As shown in FIG. 15, the lock lever 14 has a movement restricting portion 14a protruding toward the front. By sliding the lock lever 14 in the left-right direction, the movement restricting portion 14a moves between a position immediately behind the rear end 12c of the switch operation lever 12 and a position that is retracted to the left or right relative to the rear end 12c. When the movement restricting portion 14a is in the position behind the rear end 12c, the switch operation portion 12a cannot be pulled rearward. Accordingly, the electrical switch 13 remains in the off state and the electric motor 20 (see FIG. 10) is not activated. When the movement restricting portion 14a is retracted to the left or right relative to the rear end 12c, as shown in FIG. 16, the switch operation portion 12a can be pulled rearward. Therefore, the electrical switch 13 can be turned on and the electric motor 20 can be activated.

A series of operations in which the driver 35 strikes the driving member N are described with reference to FIGS. 6 to 14. The rotation member 31 having the hammer 31a is normally positioned in the striking position P1 by the biasing force of the spring 33. As shown in FIG. 10, the impact-receiving portion 35b of the driver 35 is pushed upward by the driving member N held by the nail guide 37, and thereby projects above the hammer-side opening 36c of the driver guide 36. When the lock release lever 14 is in the lock release position, the user can pull the switch operation portion 12a rearward, thereby turning the electrical switch 13 on. The electric motor 20 is powered by the battery 11. As shown in FIG. 6, the driving force of the electric motor 20 is decelerated by the speed reduction mechanism 21 in the gear housing 6 and transmitted to the spindle 24. The rotational power of the spindle 24 is further reduced by the planetary reduction mechanism 22 and transmitted to the carrier 27 and the rotation member 31. As a result, the spindle 24, the carrier 27, and the rotation member 31each rotate about the hammer rotation axis J3.

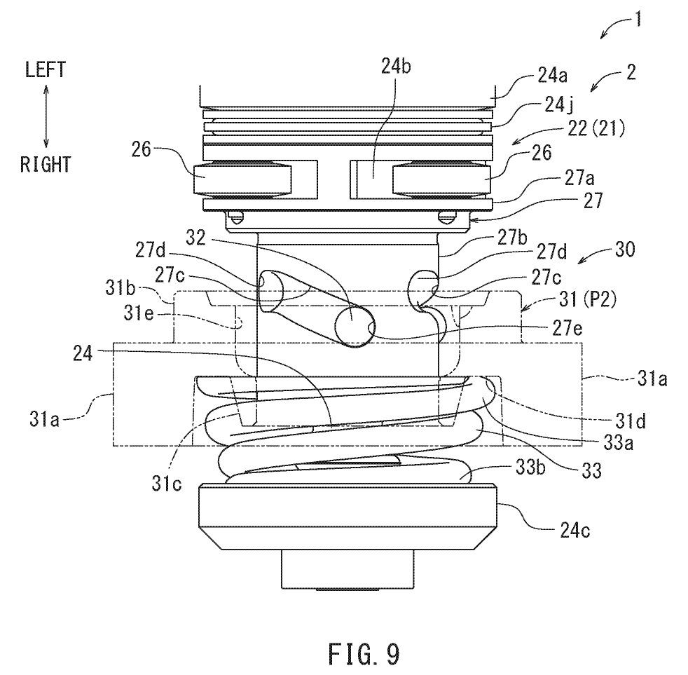

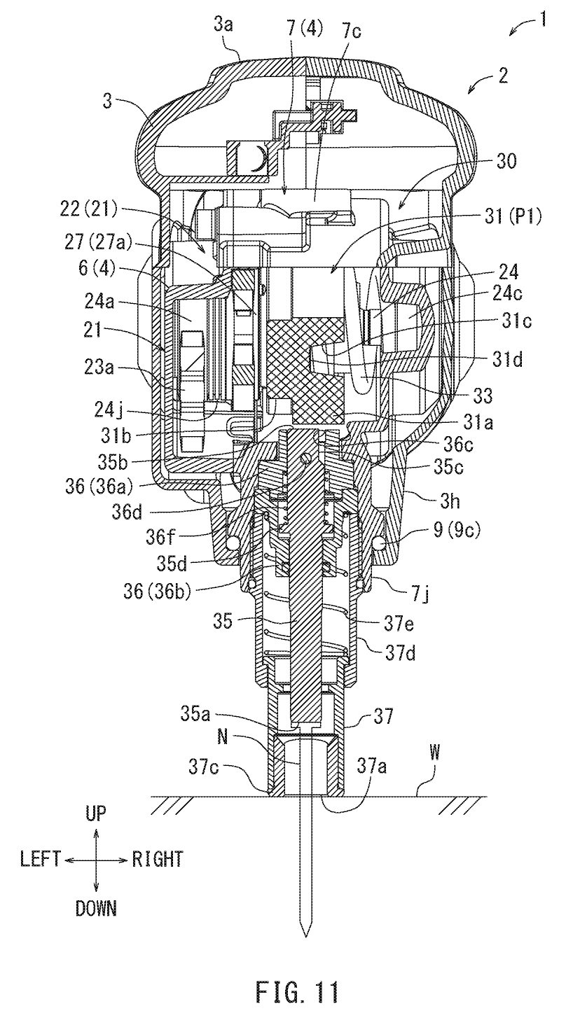

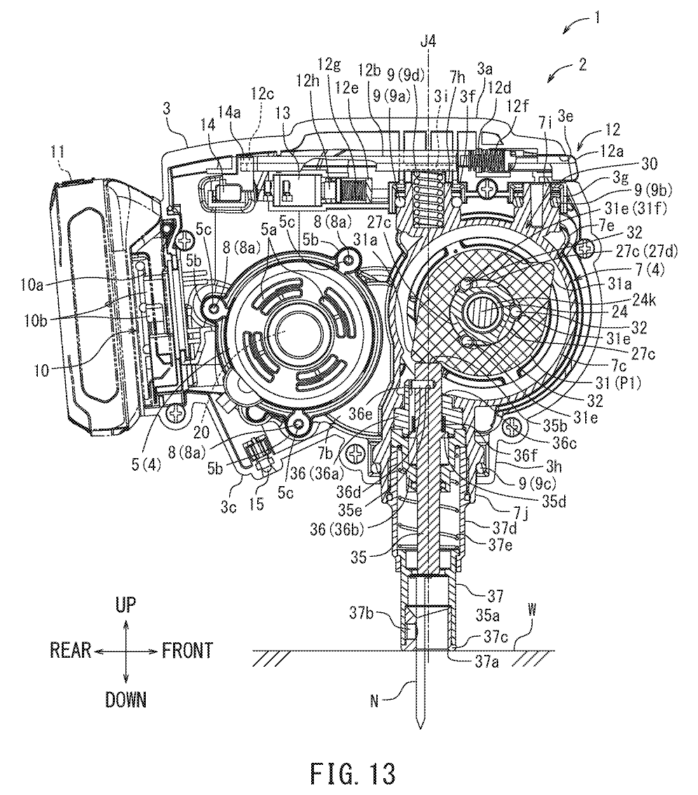

As shown in FIGS. 11 and 13, when the rotation member 31 rotates at the striking position P1, the hammer 31a strikes the impact-receiving portion 35b of the driver 35. The rotation of rotation member 31 about its axis is prevented by the impact-receiving portion 35b, whereby the hammer 31a engages (contacts) the impact-receiving portion 35b. The hammer 31a presses the impact-receiving portion 35b downward and receives an upward reaction force upward from the impact-receiving portion 35b. When the reaction force acting on the hammer 31a exceeds a predetermined level, the rotation member 31 moves relative to the carrier 27 in a direction opposite to the rotational direction. The carrier 27 and the rotation member 31 are connected by engagement of the cam grooves 27c, 31e and the balls 32. As the rotation member 31 rotates relative to the carrier 27, the balls 32 moves from impact end positions 27d, 31f to retracted end position 27e, 31g within the cam grooves 27c, 31e. As a result, the rotation member 31 moves from the striking position P1 to the retracted position P2 against the biasing force of the spring 33 while relatively rotating with respect to the carrier 27 (see FIGS. 7 and 9).

When the rotation member 31 moves to the retracted position P2 as shown in FIG. 12, the hammer 31a disengages from (does not contact) the impact-receiving portion 35b. As a result, the rotation member 31 rotates without interference of the impact-receiving portion 35b. The rotation member 31 is biased by the spring 33 from right to left. Therefore, while rotating about its axis, the rotation member 31 is urged to return to the striking position P1 (see FIG. 11). As shown in FIGS. 10 and 13, the ball 32 moves from the retracted end position 27e, 31g to the impact end position 27d, 31f within the cam grooves 27c, 31e. When returning to the striking position P1, the hammer 31a of the rotation member 31 strikes the impact-receiving portion 35b again while rotating about its axis. By repeating the above series of operations, the hammer 31a repeatedly strikes the driver 35, whereby the driver 35 repeatedly strikes the head of the driving member N.

During the series of operation described above, the assist member 24c that supports the second end 33b of the spring 33 rotates at a higher rotational speed than the rotation member 31 that supports the first end 33a of the spring 33. Therefore, when the rotation member 31 is biased by the spring 33 and rotates about its axis while returning from the retracted position P2 to the striking position P1, the second end 33b of the spring 33 rotates about the hammer rotation axis J3 ahead of the first end 33a. As a result, the rotation member 31 rotates at a higher rotational speed while being pulled by the second end 33b of the spring 33. Accordingly, the impact force exerted when hammer 31a strikes the impact-receiving portion 35b of the driver 35 increases.

As described above and as shown in FIGS. 3 and 10, the driving tool 1 has the speed reduction mechanism 21, the hammer 31a, the inner housing 4, and the outer housing 3. The speed reduction mechanism 21 reduces the output of the electric motor 20. The hammer 31a strikes the driver 35 using the output transmitted from the speed reduction mechanism 21. The inner housing 4 houses the electric motor 20, the speed reduction mechanism 21, and the hammer 31a. The outer housing 3 encloses the inner housing 4 and is provided with the grip 3a. The driving tool 1 has the elastic coupling mechanism 9. The elastic coupling mechanism 9 elastically couples the inner housing 4 and the outer housing 3 so as to allow relative movement.

Therefore, the inner housing 4 can move elastically relative to the outer housing 3. When the hammer 31a strikes the driver 35, a reaction force in the direction opposite to the striking direction is transmitted to the inner housing 4, causing the inner housing 4 to move in the opposite direction (reverse direction). Since the inner housing 4 moves elastically with respect to the outer housing 3, vibration can be suppressed from being transmitted to the outer housing 3. As a result, vibration transmitted to the grip 3a is also suppressed.

As shown in FIGS. 3, 10, and 14, the elastic coupling mechanism 9 has the spring 9d. The spring 9d biases the inner housing 4 in the striking direction. Therefore, when the inner housing 4 receives a reaction force in the direction opposite to the striking direction, the spring 9d absorbs the reaction force. Accordingly, when the hammer 31a strikes the driver 35, transmission of vibration from the inner housing 4 to the outer housing 3 is suppressed. Furthermore, the spring 9d elastically urges the inner housing 4, which has moved in the reverse direction, back toward its initial position in the striking direction. Thus, transmission of reaction forces repeatedly generated as the hammer 31a repeatedly strikes the driver 35 from the inner housing 4 to the outer housing 3 is also suppressed.

As shown in FIGS. 3 and 10, the spring 9d is interposed between the upper protrusion 7h on the upper outer surface of the inner housing 4 and the spring seat 3i on the upper inner surface of the outer housing 3 facing the upper protrusion 7h. Therefore, the spring 9d is disposed at a location where the inner housing 4 is likely to come into contact with the outer housing 3 when the inner housing 4 moves in the reverse direction. Thus, vibration transmitted from the inner housing 4 to the outer housing 3 can be efficiently suppressed.

As shown in FIGS. 3 and 10, the spring 9d is located along the driver movement axis J4. Therefore, the reaction force in the reverse direction received by the hammer 31a from the driver 35 can be efficiently absorbed by the spring 9d.

As shown in FIGS. 3 and 10, the inner housing 4 is provided with protrusions 7h, 7i, 7j, each protruding outward. The outer housing 3 is provided with the guide portions 3f, 3g, 3h. The guide portions 3f, 3g, 3h respectively guide the protrusions 7h, 7i, 7j in the striking direction. Therefore, the inner housing 4 can be guided to move with respect to the outer housing 3 in a direction along the striking direction by the protrusions 7h, 7i, 7j and guide portions 3f, 3g, 3h. Accordingly, the inner housing 4 is prevented from moving in a direction inclined relative to the striking direction. This prevents the inner housing 4 from undesirably coming into contact with the outer housing 3, thereby suppressing vibration transmitted to the outer housing 3.

As shown in FIG. 10, the inner housing 4 is provided with the upper protrusions 7h, 7i and the lower protrusion 7j. The outer housing 3 is provided with upper guide portions 3f, 3g and the lower guide portion 3h. The upper guide portions 3f and 3g guide the upper protrusions 7h and 7i, respectively, and the lower guide portion 3h guides the lower protrusion 7j. The lower protrusion 7j also serves as a driver housing portion to accommodate the driver 35. Therefore, the inner housing 4 is elastically coupled to the outer housing 3 at the lower protrusion 7j. Moreover, the inner housing 4 is elastically coupled to the outer housing 3 at the upper protrusion portions 7h and 7i on the opposite side of the lower protrusion 7j. With the elastic coupling mechanism 9 provided on both the striking direction side and the reverse direction side, the inner housing 4 can be stably supported.

As shown in FIGS. 3 and 10, the elastic members 9a, 9b, and 9c of the elastic coupling mechanism 9 are interposed between the outer circumferential surfaces of the protrusions 7h, 7i, and 7j and the inner circumferential surfaces of the guide portions 3f, 3g, and 3h. Therefore, by interposing the elastic members 9a, 9b, and 9c, direct contact between the outer circumferential surfaces of the protrusions 7h, 7i, and 7j and the inner circumferential surfaces of the guide portions 3f, 3g, and 3h is prevented. As a result, vibration transmitted from the inner housing 4 to the outer housing 3 can be effectively suppressed.

As shown in FIGS. 3 and 10, the spring 9d of the elastic coupling mechanism 9 biases the inner housing 4 in the striking direction. The protrusion 7h serves as a spring seat that supports the spring 9d. Therefore, while maintaining a simple structure for the elastic coupling mechanism 9, the spring 9d can be supported in alignment with the striking direction.

As shown in FIG. 6, the inner housing 4 is formed by integrally connecting the motor housing 5, the gear housing 6, and the hammer housing 7. The motor housing 5 houses the electric motor 20. The gear housing 6 houses the speed reduction mechanism 21. The hammer housing 7 houses the striking mechanism 30, including the hammer 31a. Thus, each structure in the power transmission path from the electric motor 20 to the hammer 31a is accommodated in the integrally formed inner housing 4. The inner housing 4 and the accommodated structures vibrate as a unit due to the reaction force generated when the hammer 31a strikes the driver 35. Therefore, the power transmission from the electric motor 20 to the hammer 31a is prevented from being interrupted by the vibration. In addition, by elastically supporting the entire inner housing 4 and the accommodated structures with respect to the outer housing 3, vibration transmitted from the inner housing 4 to the outer housing 3 can be efficiently suppressed.

As shown in FIG. 3, the grip 3a of the outer housing 3 is located on a side opposite to the striking direction of the driver 35 and is positioned on the driver movement axis J4. Accordingly, the grip 3a, which is held by the user, is positioned on the line of action of the reaction force generated when the hammer 31a strikes the driver 35. Therefore, the inner housing 4 can move smoothly relative to the outer housing 3 in both the striking and the reverse directions while the user holds the grip 3a. This prevents the inner housing 4 and the driver 35 from tilting relative to the striking direction due to the reaction force.

As described above and as shown in FIGS. 3 and 10, the driving tool 1 (striking tool) includes the opening 37a into which a driving member (impact-receiving portion) N is inserted, and the driver 35 that strikes the driving member N. Furthermore, the driving tool 1 includes the grip 3a that is positioned on the driver movement axis J4 and on a side opposite to the opening 37a, and the switch operation portion 12a for operating the electrical switch 13 of the motor 20 that drives the driver 35. The switch operation portion 12a is located on the front surface of the outer housing 3 in proximity to the grip 3a.

Therefore, the switch operation portion 12a can be operated with the index finger, middle finger, or the like regardless of whether the grip 3a is held with the left or right hand. Accordingly, the switch operation portion 12a is easy to operate even when the grip 3a is held with either hand.

As shown in FIGS. 1 and 2, the driving tool 1 has the outer housing 3 that extends in the front-rear direction and includes a front surface. The driving tool 1 has the opening 37a that is located at a lower central position in the left-right direction of the outer housing 3. The switch operation portion 12a is located at a central position in the left-right direction of the outer housing 3. Therefore, the switch operation portion 12a can be operated with the index finger, middle finger, or the like regardless of whether the user grips the tool with the left or right hand.

As shown in FIGS. 2 and 3, the switch operation portion 12a is held on the front surface of the outer housing 3 so as to be slidable in the front-rear direction. Accordingly, the switch operation portion 12a can be pushed rearward with the index finger or the like while the grip 3a is being held. As a result, the switch operation portion 12a is easy to operate.

As shown in FIG. 10, the electrical switch 13 is located behind the driver 35. Therefore, when the battery 11 is mounted on a rear surface of the outer housing 3, for example, the electrical switch 13 can be disposed close to the battery 11.

As shown in FIG. 3, the switch operation portion 12a has the arm 12b that extends from the front surface of the outer housing 3 toward the electrical switch 13 above the driver 35. Therefore, when the switch operation portion 12a is operated, the electrical switch 13 can be operated through the arm 12b.

As shown in FIGS. 2 and 3, the driving tool 1 has the lock lever 14 that moves in the left-right direction and interferes with the arm 12b of the switch operation portion 12a. Accordingly, by moving in the left-right direction to interfere with the arm 12b, the lock lever 14 releasably locks the switch operation portion 12a.

As shown in FIGS. 3 and 10, the electrical switch 13 and the switch operation portion 12a are connected via springs, such as the return spring 12f and the buffer spring 12g. The return spring 12f and the buffer spring 12g are elastically deformed when the switch operation portion 12a is operated. Accordingly, when the switch operation portion 12a is pushed rearward, the return spring 12f and the buffer spring 12g undergo elastic deformation. These springs 12f, 12g can bias the members on the side of the electrical switch 13 rearward by their elastic forces. The size of the switch operation portion 12a may vary among products, and in some cases, the switch operation portion 12a may move excessively rearward. Even in such a case, the elastic deformation of the return spring 12f and the buffering spring 12g suppresses excessive pushing of the members on the electrical switch 13 side, thereby allowing a wider tolerance range in product design.

As shown in FIGS. 3 and 6, the driving tool 1 includes the hammer 31a that is rotated by the electric motor 20 to strike the driver 35. The rotation shaft of the electric motor 20 and the rotation shaft of the hammer 31a are arranged in the same direction. For example, by disposing the electric motor 20 and the hammer 31a side by side, they can be compactly housed in the outer housing 3.

As described above and as shown in FIGS. 2, 6, and 10, the driving tool 1 (striking tool) includes the electric motor 20, the hammer 31a, and the driver 35. The electric motor 20 has the motor shaft 20a. The hammer 31a has a rotation shaft that is disposed side by side with the electric motor 20 and extends in the same direction as the motor shaft 20a. That is, the motor rotation axis J1 and the hammer rotation axis J3 extend in the same direction. The driver 35 is positioned between the hammer 31a and the electric motor 20 and receives a striking force from the hammer 31a. Furthermore, the driving tool 1 includes the grip 3a and a driver guide, such as the driver guide 36, the guide holder 37d, and the nail guide 37, which guide the driver 35 in the up-down direction. The driver guide 36 movably supports the driver 35. The nail guide 37 has the opening 37a into which the driving member (impact-receiving portion) N is inserted. The grip 3a is positioned on the driver movement axis J4 of the driver 35 and on a side opposite to the driver guide 36.

Thus, by disposing the electric motor 20 and the hammer 31a side by side, the motor 20 and the hammer 31a can be brought close to each other. This allows the electric motor 20 to be positioned closer to the driver 35, whereby the center of gravity of the driving tool 1 can be brought closer to the motor movement axis J4. As a result, the amount of tilting of the driving tool 1 caused by the reaction force of the striking operation can be suppressed, whereby the striking operation can be performed more easily and accurately.

As shown in FIG. 6, the driving tool 1 (striking tool) has the idler gear 23a that transmits power from the electric motor 20 to the hammer 31a. The rotation shaft of the idler gear 23a is located closer to the driver guide 36 than the motor shaft 20a and the rotation shaft of the hammer 31a (see FIG. 2). Accordingly, the center of gravity of the driving tool 1 is located on the side of the driver guide 36, that is downward on the striking side. As a result, the amount of tilting of the driving tool 1 caused by the reaction force generated during the striking operation can be suppressed. In addition, the idler gear 23a suppresses bulging on the side of the grip 3a. Consequently, enlargement of the grip 3a can be prevented, thereby preventing the tool from becoming difficult to hold.

As shown in FIGS. 3 and 4, the driving tool 1 includes the motor housing 5 covering the electric motor 20, the hammer housing 7 covering the hammer 31a, and the gear housing 6 covering the idler gear 23a. The motor housing 5, the hammer housing 7, and the gear housing 6 are fastened together by fastening members 8. Therefore, the three housings can be fastened firmly.

As shown in FIGS. 4 and 6, the hammer housing 7 has the clamping portion 7a that is clamped between the motor housing 5 and the gear housing 6. Therefore, the three housings can be fastened firmly through the clamping portion 7a.

As shown in FIGS. 4 and 6, the driving tool 1 includes the inner housing 4 and the outer housing 3. The inner housing 4 includes the motor housing 5, the hammer housing 7, and the gear housing 6. The outer housing 3 covers the inner housing 4 and exposes a part of the motor housing 5. Accordingly, the driving tool 1 can be made more compact than a configuration in which entire inner housing 4 is covered by the outer housing 3.

As shown in FIG. 10, the driving tool 1 includes the opening 37a into which a driving member (impact-receiving portion) N is inserted from below, and the driver 35 that moves downward to strike the driving member N. The grip 3a is positioned on the driver movement axis J4 of the driver 35 and on the upper surface of the outer housing 3. The battery attachment portion 10 is formed on the rear surface of the outer housing 3 and the battery 11 is slidably attached to the battery attachment portion 10.

Since the battery 11 is slidably attached to the rear surface of the outer housing 3, the battery 11 can be attached more easily than in a configuration where the battery 11 is inserted into the outer housing 3. In addition, the driving tool 1 is a palm-grip type in which the grip 3a is positioned on the driver movement axis J4. Consequently, tilting of the driving tool 1 caused by the reaction force of the striking operation can be suppressed by the user’s hand.

As shown in FIGS. 2 and 3, the battery attachment portion 10 has the rail 10a along which the battery 11 is slidable in the up-down direction for attachment. Accordingly, the battery 11 is prevented from projecting in the left-right direction from the tool main body.

As shown in FIGS. 3 and 10, the driving tool 1 includes the hammer 31a that rotates to strike the driver 35 and the electric motor 20 that is positioned between the hammer 31a and the battery attachment portion 10 and outputs power to the hammer 31a. Accordingly, the electric motor 20 is positioned close to both the hammer 31a and the battery 11, whereby the center of gravity of the tool main body 2 can be brought closer to the driver movement axis J4.

As shown in FIGS. 2 and 3, the work light 15 is provided in the lower portion of the outer housing 3. Therefore, the area near the opening 37a where the driving member N is inserted can be illuminated by the work light 15.

As shown in FIGS. 2 and 3, the outer housing 3 is provided with the protrusion 3c protruding downward from the battery attachment portion 10. The work light 15 is attached to the protrusion 3c such that the work light 15 faces downward. Therefore, the work light 15 is brought closer to the vicinity of the opening 37a by utilizing the protrusion 3c. This enables the vicinity of the opening 37a to be efficiently illuminated.

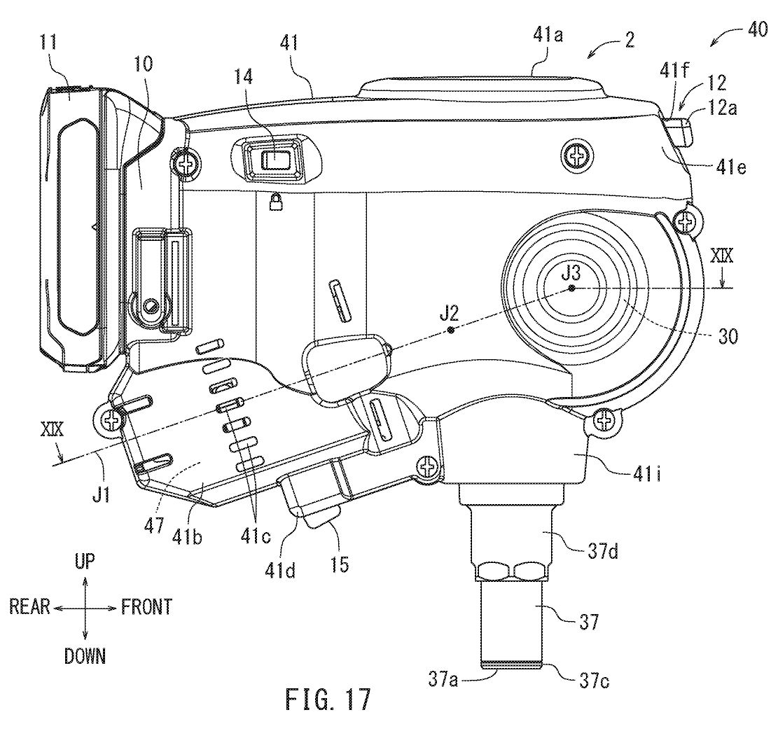

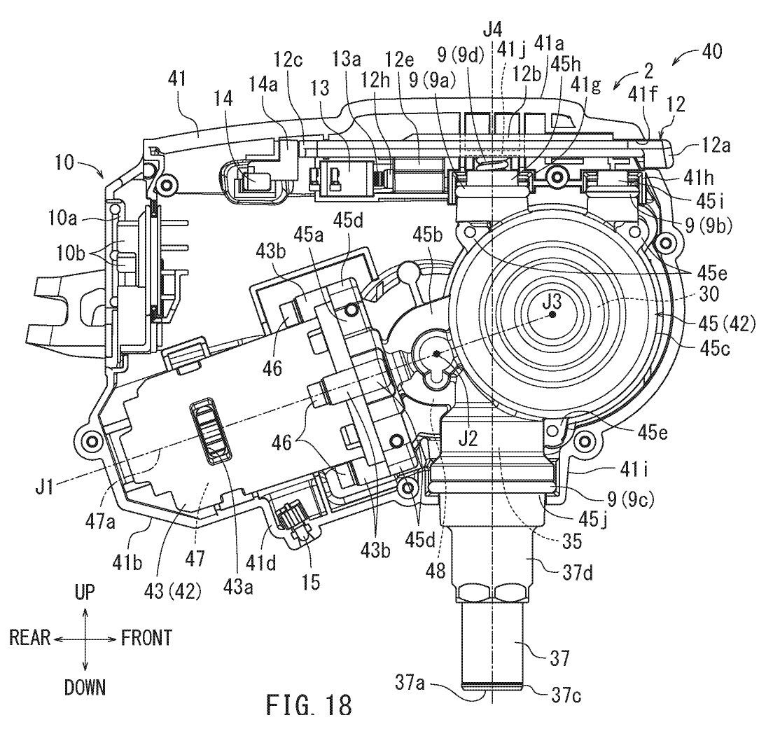

Next, the second embodiment of the present disclosure will be described with reference to FIGS. 17 to 20. As shown in FIG. 17, a driving tool (striking tool) 40 of the second embodiment differs from the first embodiment primarily in the arrangement and orientation of the electric motor. As shown in FIG. 18, the driving tool 40 of the second embodiment is provided with an outer housing 41 and an inner housing 42 instead of the outer housing 3 and inner housing 4 of the first example (see FIG. 3). The inner housing 42 houses an electric motor 47, a speed reduction mechanism 48, and a striking mechanism 30. In the speed reduction mechanism 48, the planetary reduction mechanism 22 is the same as that of the first example. In the following description, only the components that differ from the first embodiment will be described in detail.

As shown in FIG. 17, the outer housing (main body housing) 41 has a grip 41a, protrusion 41d, curved portion 41e, through hole 41f, and guide portion 41i similar to the grip 3a, protrusion 3c, curved portion 3d, through hole 3e, and guide portion 3h (see FIG. 1). The nail guide 37 protrudes downward from the guide portion 41i. The protrusion 41d is provided with the work light 15 that illuminates light toward the lower region of the opening 37a. The switch operation portion 12a of the switch operation lever 12 protrudes forward from the through hole 41f. The switch operation portion 12a is positioned forward from the curved portion 41e when not being pulled rearward. The battery attachment portion 10 is provided on the rear surface of the outer housing 41.

As shown in FIGS. 17 and 18, a motor housing compartment 41b is provided in the lower rear portion of the outer housing 41. The motor housing compartment 41b is tubular and has its axial direction inclined upward from the lower region of the battery attachment portion 10 toward the front. The rear portion of the motor housing compartment 41b is bulged rearward below the battery attachment portion 10. A part of the motor housing compartment 41b overlaps the battery attachment portion 10 in the up-down direction. The motor housing compartment 41b is located above the protrusion 41d. The motor housing compartment 41b covers the motor housing 43 from the outside. Vent holes 41c that penetrate the motor housing compartment 41b are provided on the right and left side surfaces of the motor housing compartment 41b.

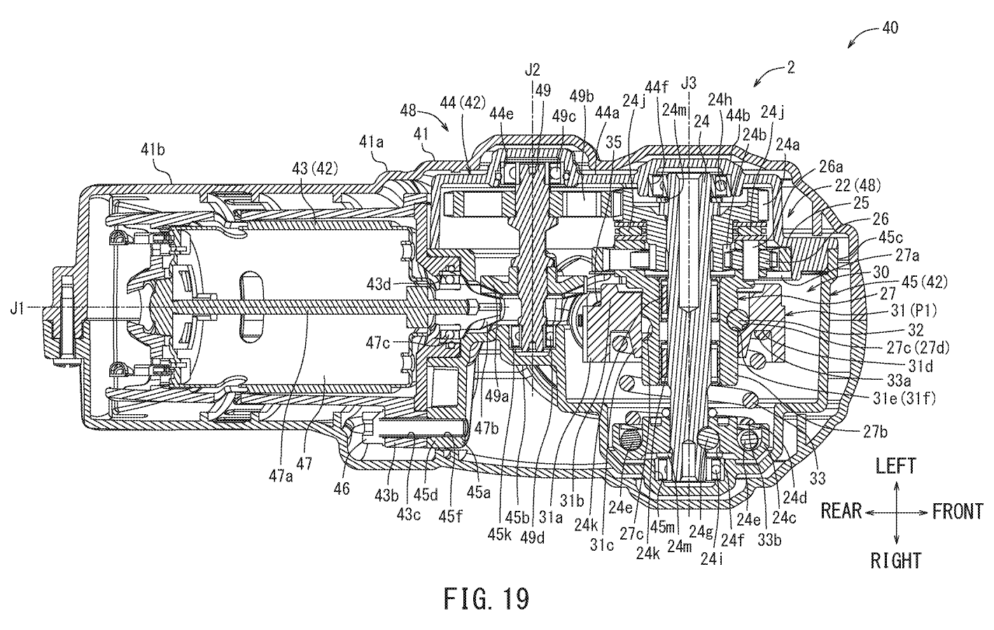

As shown in FIG. 18, the motor rotation axis J1 of the motor 47 extends in the front-rear direction and tilted upward toward the front. The intermediate shaft rotation axis J2 of the intermediate shaft 49 of the speed reduction mechanism 48 (see FIG. 19) and the hammer rotation axis J3 of the striking mechanism 30 extend in the left-right direction in parallel with each other and is disposed on an extension of the motor rotation axis J1of the motor 47. The driver movement axis (striking axis) J4, along which the driver 35 (FIG. 19) moves, extends in the up-down direction, substantially perpendicular to the intermediate shaft rotation axis J2 and the hammer rotation axis J3. The intermediate shaft rotation axis J2 is positioned between the driver movement axis J4 and the motor shaft 47 in the front-rear direction. The hammer rotation axis J3 is positioned forward of the driver movement axis J4 and above the intermediate shaft rotation axis J2. The intermediate shaft rotation axis J2 is positioned so as to overlap the striking mechanism 30 in the up-down direction. The hammer rotation axis J3 is positioned to overlap the battery attachment portion 10 in the up-down direction.

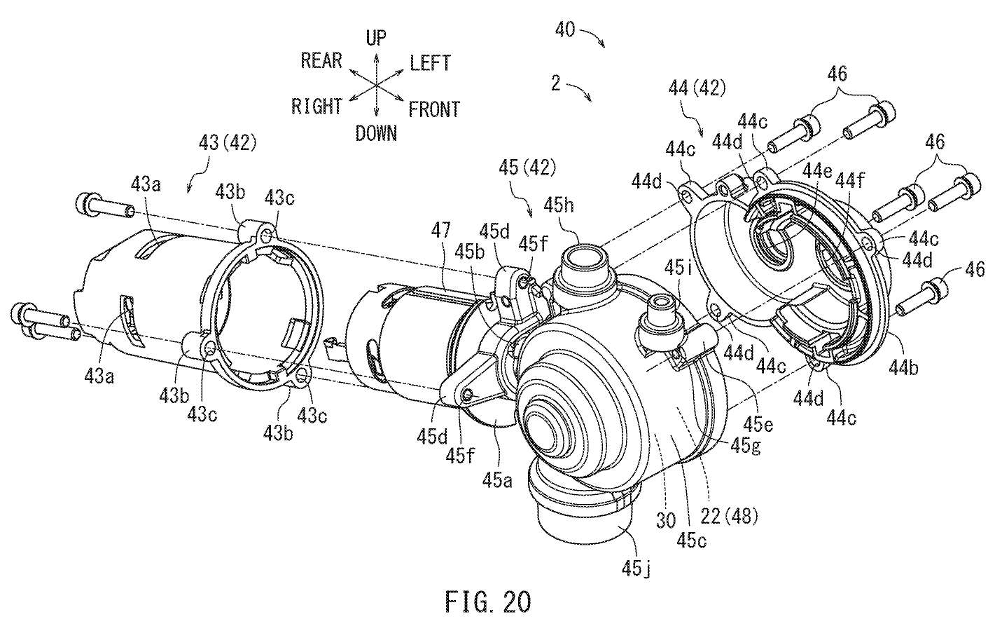

As shown in FIG. 20, the inner housing 42 is formed by integrally assembling the motor housing 43, the gear housing 44, and the hammer housing 45 with a plurality of fastening members (hex socket head bolts) 46. The motor housing 43 that houses the electric motor 47 is tubular and has a bottom at the rear and an opening at the front. Vent holes 43a that penetrate the motor housing 43 are provided on side surfaces of the motor housing 43. A plurality of bosses 43b protruding radially outward are provided on the outer circumferential surface of the front portion of the motor housing 43. Each boss 43b is provided with a through hole 43c that penetrates the boss in the axial direction of the electric motor 47.

As shown in FIG. 20, the gear housing 44 includes the intermediate shaft compartment 44a and the spindle compartment 44b that are connected with each other. The intermediate shaft compartment 44a is tubular has a bottom on the left side and an opening on the right side. The intermediate shaft compartment 44a accommodates the intermediate shaft 49 and drive-side spur gear 49b, which are described below (see FIG. 1). The spindle compartment 44b is connected to the front portion of the intermediate shaft compartment 44a. The spindle compartment 44b is tubular and has a bottom on the left side and an opening on the right side. The spindle compartment 44b accommodates the spindle 24 and the left portion of the planetary reduction mechanism 22 (see FIG. 1). A plurality of bosses 44c extending radially outward are provided on the outer circumferential surface of the gear housing 44. The bosses 44c are tubular and extends in the left-right direction. Each boss 44c is provided with a through hole 44d that penetrates the boss in the left-right direction.

As shown in FIG. 20, the hammer housing 45 includes a motor cap 45a, an intermediate shaft compartment 45b, and a striking mechanism unit 45c, which are integrally connected. The motor cap 45a is formed in a disc shape and covers the motor housing 43 from the front. The motor cap 45a also functions as a motor housing for accommodating the electric motor 47. The intermediate shaft compartment 45b is disposed between the front of the motor cap 45a and the rear of the striking mechanism compartment 45c. As shown in FIG. 19, the intermediate shaft compartment 45b cooperates with an intermediate shaft compartment 44a to accommodate the intermediate shaft 49, a driving-side bevel gear 47b, and driven-side bevel gear 49a, which are described below. In other words, the intermediate shaft compartment 45b also functions as a gear housing.

As shown in FIG. 20, the striking mechanism compartment 45c is tubular and has a bottom on the right side and an opening on the left side. As shown in FIG. 19, the striking mechanism compartment 45c cooperates with the spindle compartment 44b to accommodate the right portion of the planetary reduction mechanism 22 and the striking mechanism 30. In other words, the spindle compartment 44b also functions as a hammer housing.

As shown in FIG. 20, a plurality of bosses 45d protruding radially outward are provided on the outer circumferential surface of the motor cap 45a. Each boss 45d has a female threaded portion 45f formed on its inner circumferential surface and extending in the axial direction of the motor 47. A plurality of bosses 45e extending radially outward are provided on the outer circumferential surface of the striking mechanism compartment 45c. Each boss 45e has a female threaded portion 45g formed on its inner circumferential surface of the boss 45e and extending from the left end to the right. A plurality of fastening members 46 are inserted through the respective through holes 43c of the motor housing 43 and fastened to the respective female threaded portions 45f of the hammer housing 45. A plurality of fastening members 46 are inserted through the respective through holes 44d of the gear housing 44 and fastened to the respective female thread portions 45g of the hammer housing 45.

The electric motor 47 shown in FIG. 19 is a DC brush motor. The motor shaft 47a of the electric motor 47 protrudes forward along the motor rotation axis J1. A bearing 47c that rotatably supports the motor shaft 47a is inserted through and supported by a circular holes 43d in the front surface of the motor housing 43. A drive-side bevel gear 47b is attached to the front end of the motor shaft 47a.

As shown in FIG. 19, the intermediate shaft 49 is housed in the gear housing 44 and the hammer housing 45 and extends on the idler gear rotation axis J2 in the left-right direction. The intermediate shaft 49 is rotatably supported by bearings 49c and 49d. The bearing 49c is supported into and supported by a circular recess 44e provided on the inner surface of intermediate shaft compartment 44a of the gear housing 44. The bearing 49d is inserted into and supported by a circular recess 45k provided on the inner surface of the intermediate shaft compartment 45b of the hammer housing 45. A driven-side bevel gear 49a that engages the drive-side bevel gear 47b is attached on the right portion of the intermediate shaft 49. A drive-side spur gear 49b that engages the driven-side spur gear 24a is attached on the left portion of the intermediate shaft 49.

As shown in FIG. 10, the spindle 24 is housed in the gear housing 44 and the hammer housing 45 and extends on the hammer rotation axis J3 in the left-right direction. The bearing 24h that supports the spindle 24 is inserted into and supported by a circular recess 44f provided on the inner surface of the spindle compartment 44b of the gear housing 44. The bearing 24i is inserted into and supported by a circular recess 45m provided on the inner surface of the striking mechanism compartment 45c of the hammer housing 45. The driven-side spur gear 24a is attached at the left end of the spindle 24, . A two-stage speed reduction mechanism 21 is formed between the drive-side bevel gear 47b and the driven-side spur gear 24a of the spindle 24.

As shown in FIGS. 18 and 20, the upper outer surface of the hammer housing 45 is provided with upper protrusions 45h, 45i similar to the upper protrusions 7h, 7i of the first embodiment .(see FIG. 3) The lower outer surface of the hammer housing 45 is provided with a lower protrusion 45j similar to the lower protrusion 7j of the first embodiment (see FIG. 3). The upper protrusion 45h and the lower protrusion 45j are arranged above and below about the driver movement axis J4. The lower protrusion 45j functions as a driver housing to accommodate the driver 35 and the driver guide 36. The outer housing 41 is provided with guide portions 41g , 41h, and 41i (see FIG. 18) similar to the guide portions 3f, 3g, and 3h of the first embodiment (see FIG. 3). An elastic member such as a rubber O-ring is interposed, as an elastic coupling mechanism 9, between the outer circumferential surface of the upper protrusions 45h, 45i, and lower protrusion 45j, and the inner circumferential surfaces of the guide portions 41g, 41h, and 41i. A spring 9d, a coil spring, is inserted into the inner recess of the upper protrusion 45h, as the elastic coupling mechanism 9. A spring seat 41j is provided for receiving the upper end of the spring 9d on the upper surface of the guide portion 41g of the outer housing 41. Consequently, the entire inner housing 42 is elastically held so as to avoid direct contact with the outer housing 41.

The driving tool 40 of the second embodiment described above provides the same effects as the driving tool 1 of the first embodiment. For example, the hammer 31a can increase the striking force for driving the driver 35.

According to the striking tool 40 of the second embodiment described above, the same effects as those of the striking tool 1 of the first embodiment are obtained. For example, whether the grip 41a is held with the left or right hand, the switch operation portion 12a can be operated with the index finger, middle finger, or the like . Therefore, the switch operation portion 12a can be easily operated regardless of which hand holds the grip 41a.

As shown in FIGS. 18 and 19, the driving tool 40 includes the hammer 31a rotates by means of the electric motor 47 to strike the driver 35. The motor shaft 47a of the electric motor 47 is oriented so that the motor rotation axis J1 intersects the hammer rotation axis J3 of the hammer 31a. Therefore, for example, by orienting the longitudinal direction of the electric motor 47 in the front-rear direction, the width of the grip 41a can be made suitable for easy gripping.

The striking tool 40 of the second embodiment described above also provides the same effects as the striking tool 1 of the first embodiment. For example, since the battery 11 is slid onto the rear surface of the outer housing 41, the battery 11 can be attached to the outer housing 41 more easily than in a structure in which the battery 11 is inserted into the outer housing 41. Moreover, the driving tool 40 is of a palm‑grip type having the grip portion 41a on the driver movement axis J4 of the driver 35. Therefore, the user’s hand can suppress tilting of the driving tool 40 caused by reaction forces during striking.

As shown in FIGS. 18 and 19, the driving tool 40 includes the hammer 31a that rotates to strike the driver 35, and an electric motor 47 that is positioned between the hammer 31a and the battery attachment portion 10 and outputs power to the hammer 31a. Accordingly, the electric motor 47 is positioned close to both the hammer 31a and the battery 11, allowing the center of gravity of the main body of the driving tool 40 to be brought closer to the driver movement axis J4.

As shown in FIG. 18, the driving tool 40 includes the motor housing compartment 41b (motor housing) that houses the motor housing 43. The electric motor 47 is arranged such that the motor rotation axis J1 intersects the hammer rotation axis J3 and extends in the front‑rear direction. The rear portion of the motor housing compartment 41b bulges downward below the battery attachment portion 10. Therefore, because the electric motor 47 extends in the front-rear direction, the width of the driving tool 40 can be reduced, making the tool easier to grip. Furthermore, since the electric motor 47 is arranged such that its rear portion protrudes downward, the front-rear length of the driving tool 40 is shortened. In addition, because the electric motor 47 is inclined, the center of gravity of the motor 47 is located closer to the striking portion, reducing the tendency of the driving tool 40 to tilt during striking.

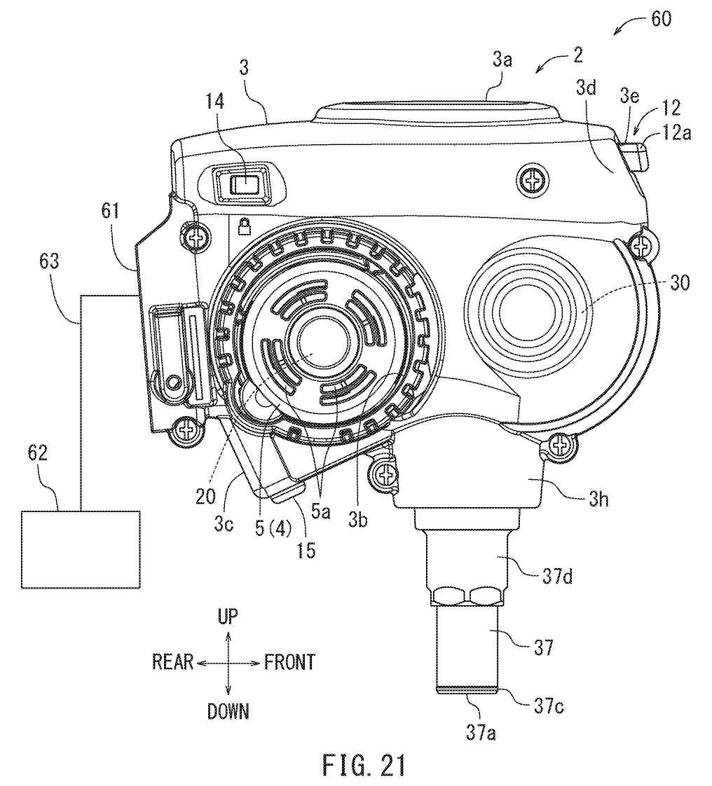

Next, a third embodiment of the present disclosure will be described with reference to FIG. 21. The driving tool (striking tool) 60 of the third embodiment includes a battery adapter 61 on the rear surface of the outer housing 3 instead of the battery attachment portion 10 of the first embodiment (see FIG. 2). The battery adapter 61 is electrically connected, via a connection cord 63, to a power source such as a battery 62 that is placed at a location remote from the driving tool 60. Electric power is supplied from the battery 62 to the electric motor 20 and other electric components. The driving tool 60 of this third embodiment also has the same effects as the driving tool 1 of the first embodiment.

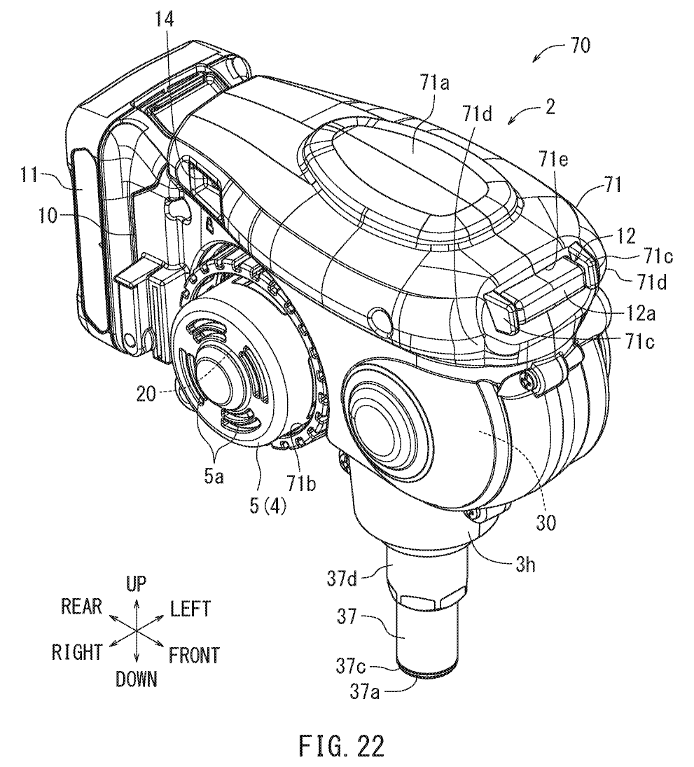

Next, a fourth embodiment of the present disclosure will be described with reference to FIG. 2. As shown in FIG. 22, a driving tool (striking tool) 70 the fourth embodiment includes an outer housing (main body housing) 71 instead of the outer housing 3 of the first embodiment (see FIG. 1). In the following description, only the components that differ from the first embodiment will be described in detail.

As shown in FIG. 22, the outer housing (main body housing) 71 includes a grip 71a, an exposed opening 71b, a curved portion 71d, and a through hole 71e , similar to the grip 3a, the exposed opening 3b, the curved portion 3d, and the through hole 3e (see FIG. 1). A bulged portion 71c that bulges forward is provided on the upper front surface of the outer housing 71. The bulged portion 71c is formed into a plate-like shape and extends in the front-rear and up-down directions. The bulged portion 71c is provided immediately on both sides of the switch operation portion 12a. The upper end of the bulged portions 71cextend above the upper end of the switch operation portion 12a. The lower end of the bulged portions 71c extend below the lower end of the switch operation portion 12a.

As shown in FIG. 21, the bulged portions 71c protrude forward beyond the switch operation portion 12a in its initial state when it is not pulled rearward. Therefore, the left and right end portions of the switch operation portion 12a are covered by the bulged portions 71c. This prevents unintended pulling operation of the switch operation portion 12a. Accordingly, the driving tool 70 described above can achieve the same effects as the driving tool 1 of the first embodiment.

As shown in FIG. 22, the bulged portions 71c that bulge forward are provided on the front surface of the outer housing 3 on both sides of the switch operation portion 12a. Therefore, the grip 71a can be easily held by hooking the fingers onto the bulged portions 71c. Alternatively, the bulged portions 71c can prevent the switch operation portion 12a from external damage.

Various modifications can be made to the driving tool 1, 40, 60, and 70 described in the above embodiments. For example, a palm-grip type striking tool that is held from above is illustrated. Instead, a striking tool having a column-shaped grip extending from the tool main body may be used. In the embodiments, a tool that drives driving members one by one by utilizing a striking mechanism is illustrated. Instead, the present disclosure may be applied to other types of striking tools, such as impact drivers, impact wrenches, hammer drills, and other similar striking tools.

In the embodiments, a driving tool for driving nails is illustrated. Instead of nails, a wooden dowel, a metal dowel, or a female-threaded anchor, for example, may be driven into a workpiece by utilizing the striking mechanism.

In the embodiments, a DC brushed motor is illustrated as the driving source. Instead, a DC brushless motor may be employed. The number of reduction stages from the motor to the hammer is not limited to that shown in the embodiments. For example, a planetary reduction mechanism may be configured to perform speed reduction in two or more stages. Alternatively, the tool may have a configuration in which no speed reduction is performed between the motor and the spindle.

In the embodiments, a battery attachment portion 10 is provided on the rear surface of the outer housing 3, and allows the battery 11 to slide in the up-down direction for attachment and detachment. The battery attachment portion 10 may be configured such that the battery 11 is attached by sliding it downward along the rail 10a from above, or by sliding it upward along the rail 10a from below. Alternatively, the battery may be configured to slide in the left-right direction for attachment and detachment. Furthermore, a battery attachment portion may be provided on the upper surface, or on either side surface of the outer housing.

In the embodiments, O-rings 9a, 9b, 9c and a spring 9d are illustrated as elastic members that elastically retain the inner housing relative to the outer housing. The types, locations, and numbers of these elastic members are not limited to those shown in the embodiments and may be modified as appropriate. For example, a block-shaped rubber member or a spring member may be used in place of the O-rings.

In the embodiments, the spindle 24 and the assist member 24c are prevented from rotating relative to each other by the engagement of the ball-shaped anti-rotation member 24g and the groove portion 24f. Instead, for example, the assist member may be fastened to the spindle with a screw.

In the embodiment, the outer housing 3 is configured to expose a part of the motor housing 5. Instead, the outer housing 3 may cover entire inner housing 4, including the motor housing 5.

In the embodiments, the motor housing 5, the hammer housing 7 and the gear housing 6 are fastened to each other by the fastening members 8. Alternatively, for example, only the motor housing 5 and the hammer housing 7 may be fastened to each other. Similarly, only the hammer housing 7 and the gear housing 6 may be fastened to each other.

In the embodiments, the rotation shaft (intermediate shaft) 23 of the idler gear 23a is positioned closer to the driver guide 36 than the motor shaft 20a and the rotation shaft of the hammer 31a. Alternatively, the rotation shaft of the idler gear may be positioned farther from the driver guide 36 than motor shaft 20a or the rotation shaft of the hammer 31a.

In the embodiment, the lock lever 14 slides in the left-right direction to interfere with the arm 12b of the switch operation portion 12a. Alternatively, the lock lever 14 may be configured to tilt in both the left-right and front-rear directions. Alternatively, the lock lever 14 may be omitted.

In the embodiments, the bulged portions 71c that bulge forward are provided on the front surface of outer housing 71 on both the left and right sides of switch operation portion 12a. The shape and size of the bulged portions may be appropriately modified. For example, the foremost end of the bulged portion may be positioned forward of the foremost end of the switch operation portion 12a.

In the embodiments, the electrical switch 13 and the switch operation portion 12a are connected via a return spring 12f and a buffer spring 12g. Alternatively, the electrical switch 13 and the switch operation portion 12a may be connected via either the return spring 12f or the buffer spring 12g alone.

In the embodiment, the electrical switch 13 is located behind the driver 35. The switch operation portion 12a includes an arm 12b that extends from the front surface of the outer housing 3 toward the electrical switch 13 above the driver 35. Alternatively, for example, the electrical switch 13 may be positioned forward of the driver 35. In such a configuration, the switch operation portion 12a may omit the arm 12b.

In the embodiments, the switch operation portion 12a is positioned substantially at the left-right center of the front surface of the outer housing 3. Alternatively, the switch operation portion 12a may be arranged such that its right or left end is located at the left-right center. Even in this arrangement, the switch operation portion 12a remains easy to operate when the grip 3a is held.

In the embodiments, the hammer housing 7 has a clamping portion 7a that is clamped between the motor housing 5 and the gear housing 6. Alternatively, the hammer housing 7 may omit the clamping portion 7a.

In the embodiments, the outer housing is provided with a work light 15. Alternatively, the outer housing b may be provided without the work light 15. In the embodiment, the outer housing 3 has a protrusion 3c on which the work light 15 is mounted. Alternatively, the outer housing 3 may omit the protrusion 3c, and the work light 15 may be mounted at another location on the outer housing 3.

The battery adapter 61 of the third embodiment may be applied to the second embodiment, for example. The bulged portion 71c of the fourth embodiment may be applied to the second or third embodiment, for example.

What is claimed is:

1. A driving tool comprising:
an electric motor;
a speed reduction mechanism that reduces an output of the electric motor;
a hammer that strikes a driver in a striking direction by an output transmitted from the speed reduction mechanism;
an inner housing that houses the electric motor, the speed reduction mechanism, and the hammer;
an outer housing that encloses the inner housing and is provided with a grip; and
an elastic coupling mechanism that elastically couples the inner housing and the outer housing to allow relative movement.

2. The driving tool according to claim 1, wherein
the elastic coupling mechanism includes a spring that biases the inner housing in the striking direction.

3. The driving tool according to claim 2, wherein
the spring is interposed between an upper outer surface of the inner housing and an upper inner surface of the outer housing facing the upper outer surface.

4. The driving tool according to claim 2, wherein
the spring is located along a driver movement axis of the driver.

5. The driving tool according to claim 1, further comprising:
a protrusion provided on the inner housing and protruding outward therefrom; and
a guide portion provided on the outer housing and guiding the protrusion in the striking direction.

6. The driving tool according to claim 5, wherein
the protrusion includes an upper protrusion that protrudes upward from the inner housing and a lower protrusion that protrudes downward from the inner housing,
the guide portion includes an upper guide portion that guides the upper protrusion and a lower guide portion that guides the lower protrusion, and
the lower protrusion functions as a driver housing that accommodates the driver.

7. The driving tool according to claim 5, wherein
the elastic coupling mechanism includes an elastic member that is interposed between an outer peripheral surface of the protrusion and an inner peripheral surface of the guide portion

8. The driving tool according to claim 5, further comprising:
a spring that is provided in the elastic coupling mechanism and biases the inner housing in the striking direction,
wherein the protrusion functions as a spring seat that supports the spring.

9. The driving tool according to claim 1, wherein
the inner housing is formed by integrally connecting a motor housing that houses the electric motor, a gear housing that houses the speed reduction mechanism, and a hammer housing that houses a striking mechanism including the hammer.

10. The driving tool according to claim 1, wherein
the outer housing includes the grip that is located on a side opposite to the striking direction of the driver and is positioned on a driver movement axis of the driver.

11. The driving tool according to claim 7, wherein
the elastic member comprises a rubber member including a rubber O-ring, or a spring member.

12. The driving tool according to claim 8, wherein
the protrusion is an upper protrusion that protrudes upward and includes an inner recess, and
the spring is inserted into the inner recess of the upper protrusion, and

13. The driving tool according to claim 12, wherein
the guide portion is an upper guide portion that guides the upper protrusion into which the spring is inserted, the upper guide portion having a closed upper end that serves to receive an upper end of the spring.

14. The driving tool according to claim 6, wherein
the lower protrusion surrounds a driver guide that guides the driver along a driver movement axis of the driver.

15. The driving tool according to claim 14, wherein
the lower guide portion is a tubular member that laterally covers the lower protrusion and serves as a support of the driver guide.

16. The driving tool according to claim 9, wherein
the hammer housing includes a clamping portion that is clamped between the motor housing and the gear housing, a first idler gear compartment that houses an idler gear of the speed reduction mechanism, and a striking mechanism compartment that houses the hammer and a spindle about which the hammer is rotated to strike the driver in the driving direction, and
the clamping portion, the first idler gear compartment, and the striking mechanism compartment are integrally connected.

17. The driving tool according to claim 16, wherein
the gear housing includes a motor cap that covers an output side of the motor, a second idler gear compartment that houses the idler gear, and a spindle compartment that houses the spindle, and
the second idle gear compartment of the gear housing cooperates with the first idler gear compartment of the hammer housing to house the idler gear of the speed reduction mechanism.

18. The driving tool according to claim 1, wherein
the elastic coupling mechanism comprises an elastic member interposed between the inner housing and the outer housing and is configured to absorb at least a portion of a reaction force generated when the hammer strikes the driver.

19. The driving tool according to claim 1, wherein
the hammer is configured to rotate to strike the driver in the striking direction, and
the electric motor is arranged such that a motor rotation axis is parallel to or intersects a hammer rotation axis.

20. The driving tool according to claim 1, wherein
the outer housing includes a battery adapter configured to electrically connect the electric motor to a power source located remotely from the driving tool.
